(19) United States
(12) Patent Application Publication
(10) Pub. No.: US 2026/0219475 A1
(43) Pub. Date: Jul. 30, 2026

(54) PHOTOGRAPHING OPTICAL LENS ASSEMBLY, IMAGE CAPTURING UNIT AND ELECTRONIC DEVICE

(71) Applicant: LARGAN PRECISION CO., LTD., Taichung City (TW)

(72) Inventors: Yu-Chun KE, Taichung City (TW); Cheng-Yu TSAI, Taichung City (TW)

(73) Assignee: LARGAN PRECISION CO., LTD., Taichung City (TW)

(21) Appl. No.: 19/080,427

(22) Filed: Mar. 14, 2025

(30) Foreign Application Priority Data
Jan. 24, 2025 (TW) 114103414

(51) Int. Cl. G02B 13/00; G02B 9/12

(52) U.S. Cl. CPC G02B 13/0035; G02B 9/12

(57) ABSTRACT

A photographing optical lens assembly includes three lens elements which are, in order from an object side to an image side along an optical path: a first lens element, a second lens element and a third lens element. Each of the three lens elements has an object-side surface facing toward the object side and an image-side surface facing toward the image side. The first lens element has positive refractive power, the object-side surface of the first lens element is convex in a paraxial region thereof, and the image-side surface of the first lens element is concave in a paraxial region thereof. The third lens element has negative refractive power, the image-side surface of the third lens element is concave in a paraxial region thereof, and the image-side surface of the third lens element has at least one inflection point.

### RELATED APPLICATIONS

This application claims priority to Taiwan Application 114103414, filed on Jan. 24, 2025, which is incorporated by reference herein in its entirety.

### BACKGROUND

### Technical Field

The present disclosure relates to a photographing optical lens assembly, an image capturing unit and an electronic device, more particularly to a photographing optical lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a photographing optical lens assembly includes three lens elements. The three lens elements are, in order from an object side to an image side along an optical path, a first lens element, a second lens element and a third lens element. Each of the three lens elements has an object-side surface facing toward the object side and an image-side surface facing toward the image side.

Preferably, the first lens element has positive refractive power. Preferably, the object-side surface of the first lens element is convex in a paraxial region thereof. Preferably, the image-side surface of the first lens element is concave in a paraxial region thereof. Preferably, the third lens element has negative refractive power. Preferably, the image-side surface of the third lens element is concave in a paraxial region thereof. Preferably, the image-side surface of the third lens element has at least one inflection point.

When an Abbe number of the second lens element is V2, an Abbe number of the third lens element is V3, a focal length of the second lens element is f2, a focal length of the third lens element is f3, a central thickness of the third lens element is CT3, an axial distance between the first lens element and the second lens element is T12, a curvature radius of the object-side surface of the third lens element is R5, and a curvature radius of the image-side surface of the third lens element is R6, the following conditions are preferably satisfied:

$$10. < V 2 + V 3 < 70. ;$$

$$0 < 10 \times \vert f 3 / f 2 \vert < 4.5 ;$$

$$0.4 < CT 3 / T 12 < 2.5 ; and$$

$$0 < ( R 5 + R 6 ) / ( R 5 - R 6 ) < 2. .$$

According to another aspect of the present disclosure, a photographing optical lens assembly includes three lens elements. The three lens elements are, in order from an object side to an image side along an optical path, a first lens element, a second lens element and a third lens element. Each of the three lens elements has an object-side surface facing toward the object side and an image-side surface facing toward the image side.

Preferably, the first lens element has positive refractive power. Preferably, the object-side surface of the first lens element is convex in a paraxial region thereof. Preferably, the image-side surface of the first lens element is concave in a paraxial region thereof. Preferably, the third lens element has negative refractive power. Preferably, the image-side surface of the third lens element is concave in a paraxial region thereof. Preferably, the image-side surface of the third lens element has at least one critical point in an off-axis region thereof.

When an Abbe number of the second lens element is V2, an Abbe number of the third lens element is V3, a focal length of the photographing optical lens assembly is f, a focal length of the second lens element is f2, a focal length of the third lens element is f3, and a curvature radius of the image-side surface of the first lens element is R2, the following conditions are preferably satisfied:

$$10. < V 2 + V 3 < 70. ;$$

$$0 < 10 \times \vert f 3 / f 2 \vert < 4.5 ; and$$

$$0.8 < f / R 2 < 2 \text{.50} ;$$

When an Abbe number of the first lens element is V1, the Abbe number of the second lens element is V2, the Abbe number of the third lens element is V3, an Abbe number of the i-th lens element is Vi, a refractive index of the first lens element is N1, a refractive index of the second lens element is N2, a refractive index of the third lens element is N3, and a refractive index of the i-th lens element is Ni, at least one lens element of the photographing optical lens assembly satisfies the following condition:

$$5. < Vi / Ni < 14.5 , wherein i = 1 , 2 or 3.$$

According to another aspect of the present disclosure, a photographing optical lens assembly includes three lens elements. The three lens elements are, in order from an object side to an image side along an optical path, a first lens element, a second lens element and a third lens element. Each of the three lens elements has an object-side surface facing toward the object side and an image-side surface facing toward the image side.

Preferably, the first lens element has positive refractive power. Preferably, the object-side surface of the first lens element is convex in a paraxial region thereof. Preferably, the image-side surface of the first lens element is concave in a paraxial region thereof. Preferably, the third lens element has negative refractive power. Preferably, the image-side surface of the third lens element is concave in a paraxial region thereof. Preferably, the image-side surface of the third lens element has at least one critical point in an off-axis region thereof.

When an Abbe number of the second lens element is V2, an Abbe number of the third lens element is V3, a focal length of the second lens element is f2, a focal length of the third lens element is f3, a curvature radius of the image-side surface of the first lens element is R2, a curvature radius of the image-side surface of the third lens element is R6, an axial distance between the object-side surface of the first lens element and the image-side surface of the third lens element is TD, and an entrance pupil diameter of the photographing optical lens assembly is EPD, the following conditions are preferably satisfied:

$$10. < V 2 + V 3 < 70. ;$$

$$0 < 10 \times \vert f 3 / f 2 \vert < 7. ;$$

$$0 < R 2 / R 6 < 2. ; and$$

$$1. < TD / EPD < 1.8 .$$

According to another aspect of the present disclosure, an image capturing unit includes one of the aforementioned photographing optical lens assemblies and an image sensor, wherein the image sensor is disposed on an image surface of the photographing optical lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a perspective view of an image capturing unit according to the 8th embodiment of the present disclosure;

FIG. 16 is a perspective view of an electronic device according to the 9th embodiment of the present disclosure;

FIG. 17 is another perspective view of the electronic device in FIG. 16;

FIG. 18 is a perspective view of an electronic device according to the 10th embodiment of the present disclosure;

FIG. 19 is another perspective view of the electronic device in FIG. 18;

FIG. 20 is a block diagram of the electronic device in FIG. 18;

FIG. 21 is a perspective view of an electronic device according to the 11th embodiment of the present disclosure;

FIG. 22 is a perspective view of an electronic device according to the 12th embodiment of the present disclosure;

FIG. 23 shows a schematic view of inflection points on lens surfaces and critical points on lens surfaces according to the 1st embodiment of the present disclosure;

FIG. 24 shows a schematic view of Sag2R1, Sag2R2 and Y3R2 according to the 1st embodiment of the present disclosure;

FIG. 25 shows a schematic view of a configuration of a light-folding element in a photographing optical lens assembly according to one embodiment of the present disclosure;

FIG. 26 shows a schematic view of another configuration of a light-folding element in a photographing optical lens assembly according to one embodiment of the present disclosure; and

FIG. 27 shows a schematic view of a configuration of two light-folding elements in a photographing optical lens assembly according to one embodiment of the present disclosure.

### DETAILED DESCRIPTION

A photographing optical lens assembly includes three lens elements. The three lens elements are, in order from an object side to an image side along an optical path, a first lens element, a second lens element and a third lens element. Each of the three lens elements has an object-side surface facing toward the object side and an image-side surface facing toward the image side.

The first lens element can have positive refractive power. Therefore, it is favorable for converging light and reducing the overall size of the photographing optical lens assembly. The object-side surface of the first lens element can be convex in a paraxial region thereof. Therefore, it is favorable for adjusting the travelling direction of light, thereby reducing the total track length of the photographing optical lens assembly. The image-side surface of the first lens element can be concave in a paraxial region thereof. Therefore, it is favorable for balancing the refractive power of the first lens element, thereby improving convergence quality of light from various fields of view onto the image surface and correcting aberrations.

The object-side surface of the second lens element can be concave in a paraxial region thereof. Therefore, it is favorable for adjusting the lens shape and the refractive power of the second lens element, thereby improving image quality at the central image. The image-side surface of the second lens element can be convex in a paraxial region thereof. Therefore, it is favorable for controlling the travelling direction of light at the periphery of the second lens element, thereby preventing ineffective light convergence due to insufficient deflection of peripheral light.

The third lens element can have negative refractive power. Therefore, it is favorable for balancing the refractive power of lens elements at an image end of the photographing optical lens assembly and reducing the back focal length of the photographing optical lens assembly. The object-side surface of the third lens element can be concave in a paraxial region thereof. Therefore, it is favorable for adjusting the light incident direction into the third lens element, thereby enlarging the image surface. The image-side surface of the third lens element can be concave in a paraxial region thereof. Therefore, it is favorable for correcting field curvature while reducing the back focal length.

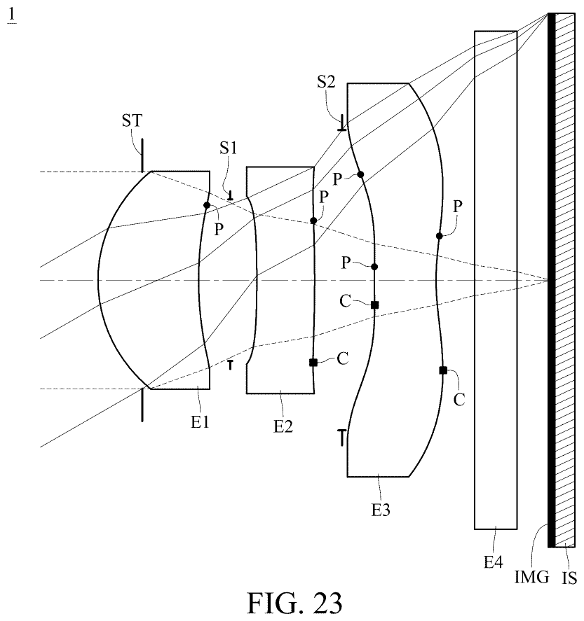

According to the present disclosure, the image-side surface of the third lens element can have at least one inflection point. Therefore, it is favorable for enhancing aberration correction ability of the third lens element for the peripheral image. Please refer to FIG. 23, which shows a schematic view of an inflection point P on the image-side surface of the third lens element E3 according to the 1st embodiment of the present disclosure. The abovementioned inflection point P on the image-side surface of the third lens element E3, as well as inflection points P on the image-side surface of the first lens element E1, the image-side surface of the second lens element E2 and the object-side surface of the third lens element E3 in FIG. 23 are exemplary. Each of lens surfaces in various embodiments of the present disclosure may also have one or more inflection points.

According to the present disclosure, the image-side surface of the third lens element can have at least one critical point in an off-axis region thereof. Therefore, it is favorable for adjusting light incident angle onto the image surface and controlling the travelling angle of peripheral light, thereby preventing vignetting at the peripheral image and correcting distortion. Please refer to FIG. 23, which shows a schematic view of a critical point C on the image-side surface of the third lens element E3 according to the 1st embodiment of the present disclosure. The abovementioned critical points C on the image-side surface of the third lens element E3, as well as critical points C on the image-side surface of the second lens element E2 and the object-side surface of the third lens element E3 in FIG. 23 are exemplary. Each of lens surfaces in various embodiments of the present disclosure may also have one or more critical points in an off-axis region thereof.

When an Abbe number of the second lens element is V2, and an Abbe number of the third lens element is V3, the following condition can be satisfied: 10.0<V2+V3<70.0. Therefore, a proper material configuration of the second and third lens elements is favorable for balancing convergence ability for light with different wavelengths. Moreover, the following condition can also be satisfied: 20.0<V2+V3<65.0. Moreover, the following condition can also be satisfied: 30.0<V2+V3<63.0. Moreover, the following condition can also be satisfied: 33.00<V2+V3<62.00. Moreover, the following condition can also be satisfied: 36.7≤V2+V3≤60.9.

When a focal length of the second lens element is f2, and a focal length of the third lens element is f3, the following condition can be satisfied: 0<10×|f3/f2|<7.00. Therefore, it is favorable for enhancing the refractive power configuration of the third lens element, with the second lens element correcting aberrations generated by the third lens element. Moreover, the following condition can also be satisfied: 0<10×|f3/f2|<4.50. Moreover, the following condition can also be satisfied: 0.01<10×|f3/f2|<3.00. Moreover, the following condition can also be satisfied: 0.05<10×|f3/f2|<2.50. Moreover, the following condition can also be satisfied: 0.11≤10×|f3/f2|≤3.99.

When a central thickness of the third lens element is CT3, and an axial distance between the first lens element and the second lens element is T12, the following condition can be satisfied: 0.40<CT3/T12<2.50. Therefore, it is favorable for balancing the lens interval of the first and second lens element and the central thickness of the third lens element, thereby balancing space arrangements of lens groups respectively at the object and image ends of the photographing optical lens assembly. Moreover, the following condition can also be satisfied: 0.60<CT3/T12<1.75. Moreover, the following condition can also be satisfied: 0.70<CT3/T12<1.50. Moreover, the following condition can also be satisfied: 0.81≤CT3/T12≤2.10.

When a curvature radius of the object-side surface of the third lens element is R5, and a curvature radius of the image-side surface of the third lens element is R6, the following condition can be satisfied: 0<(R5+R6)/(R5−R6)<2.00. Therefore, it is favorable for effectively balancing the curvature radius of the object-side surface of the third lens element and the curvature radius of the image-side surface of the third lens element so as to improve convergence quality of imaging light, thereby effectively correcting field curvature and spherical aberration. Moreover, the following condition can also be satisfied: 0.20<(R5+R6)/(R5−R6)<1.80. Moreover, the following condition can also be satisfied: 0.37≤(R5+R6)/(R5−R6)≤1.52.

When a focal length of the photographing optical lens assembly is f, and a curvature radius of the image-side surface of the first lens element is R2, the following condition can be satisfied: 0.80<f/R2<2.50. Therefore, it is favorable for adjusting the curvature radius of the image-side surface of the first lens element, such that the image-side surface of the first lens element can have a relatively strong light deflection ability to control the optical path and correct aberrations. Moreover, the following condition can also be satisfied: 0.90<f/R2<2.30. Moreover, the following condition can also be satisfied: 1.00<f/R2<1.80. Moreover, the following condition can also be satisfied: 1.07≤f/R2≤2.06.

When an Abbe number of the first lens element is V1, the Abbe number of the second lens element is V2, the Abbe number of the third lens element is V3, an Abbe number of the i-th lens element is Vi, a refractive index of the first lens element is N1, a refractive index of the second lens element is N2, a refractive index of the third lens element is N3, and a refractive index of the i-th lens element is Ni, at least one lens element of the photographing optical lens assembly can satisfy the following condition: 5.00<Vi/Ni<14.50, wherein i=1, 2 or 3. Therefore, it is favorable for improving the dispersion ability of the applied optical lens, thereby correcting excessive deflection of light with short wavelengths. Moreover, at least one lens element of the photographing optical lens assembly can also satisfy the following condition: 8.00<Vi/Ni<12.50, wherein i=1, 2 or 3. Moreover, at least one lens element of the photographing optical lens assembly can also satisfy the following condition: 9.00<Vi/Ni<12.00, wherein i=1, 2 or 3. Moreover, at least one lens element of the photographing optical lens assembly can also satisfy the following condition: 9.61≤Vi/Ni≤14.34, wherein i=1, 2 or 3.

When the curvature radius of the image-side surface of the first lens element is R2, and the curvature radius of the image-side surface of the third lens element is R6, the following condition can be satisfied: 0<R2/R6<2.00. Therefore, it is favorable for effectively balancing the curvature radius of the image-side surface of the first lens element and the curvature radius of the image-side surface of the third lens element, thereby improving convergence quality of peripheral light. Moreover, the following condition can also be satisfied: 0.50<R2/R6<1.75. Moreover, the following condition can also be satisfied: 0.60<R2/R6<1.60. Moreover, the following condition can also be satisfied: 0.69≤R2/R6≤1.50.

When an axial distance between the object-side surface of the first lens element and the image-side surface of the third lens element is TD, and an entrance pupil diameter of the photographing optical lens assembly is EPD, the following condition can be satisfied: 1.00<TD/EPD<1.80. Therefore, it is favorable for balancing the lens element size and the light incident amount, thereby obtaining a proper balance between the size of the overall lens and the illuminance at the periphery. Moreover, the following condition can also be satisfied: 1.30<TD/EPD<1.75. Moreover, the following condition can also be satisfied: 1.56≤TD/EPD≤1.68.

When the focal length of the photographing optical lens assembly is f, a curvature radius of the object-side surface of the second lens element is R3, and a curvature radius of the image-side surface of the second lens element is R4, the following condition can be satisfied: 0.30<|f/R3|+|f/R4|<1.00. Therefore, it is favorable for effectively balancing the curvature radius of the object-side surface of the second lens element and the curvature radius of the image-side surface of the second lens element to adjust the travelling direction of peripheral light, thereby correcting astigmatism of the photographing optical lens assembly and reducing stray light in the optical lens. Moreover, the following condition can also be satisfied:

$$0.4 < \vert f / R 3 \vert + \vert f / R 4 \vert < 0.9 .$$

When the curvature radius of the image-side surface of the first lens element is R2, and the curvature radius of the object-side surface of the second lens element is R3, the following condition can be satisfied: −3.00< (R2−R3)/(R2+R3)<0. Therefore, it is favorable for effectively balancing the curvature radius of the image-side surface of the first lens element and the curvature radius of the object-side surface of the second lens element, such that the first lens element can be collaborated with the second lens element to correct astigmatism and spherical aberration at the central image. Moreover, the following condition can also be satisfied: −2.60<(R2−R3)/(R2+R3)<−0.25.

When a central thickness of the first lens element is CT1, and a central thickness of the second lens element is CT2, the following condition can be satisfied: 1.30<CT1/CT2<2.30. Therefore, it is favorable for balancing the central thicknesses of the first and second lens elements so as to improve light convergence effect at the central image. Moreover, the following condition can also be satisfied:

$$1.5 < CT 1 / CT 2 < 2.00 .$$

When an axial distance between the second lens element and the third lens element is T23, and the central thickness of the third lens element is CT3, the following condition can be satisfied: 0.50<T23/CT3<1.30. Therefore, it is favorable for balancing the lens interval between the second and third lens elements and the central thickness of the third lens element, thereby adjusting the travelling direction of the optical path at the image end of the photographing optical lens assembly and increasing design flexibility. Moreover, the following condition can also be satisfied:

$$0.7 < T 23 / CT 3 < 1.15 .$$

When the Abbe number of the second lens element is V2, the following condition can be satisfied: 10.0<V2<25.0. Therefore, it is favorable for correcting chromatic aberration generated in the photographing optical lens assembly, thereby improving image quality. Moreover, the following condition can also be satisfied: 14.0<V2<20.0.

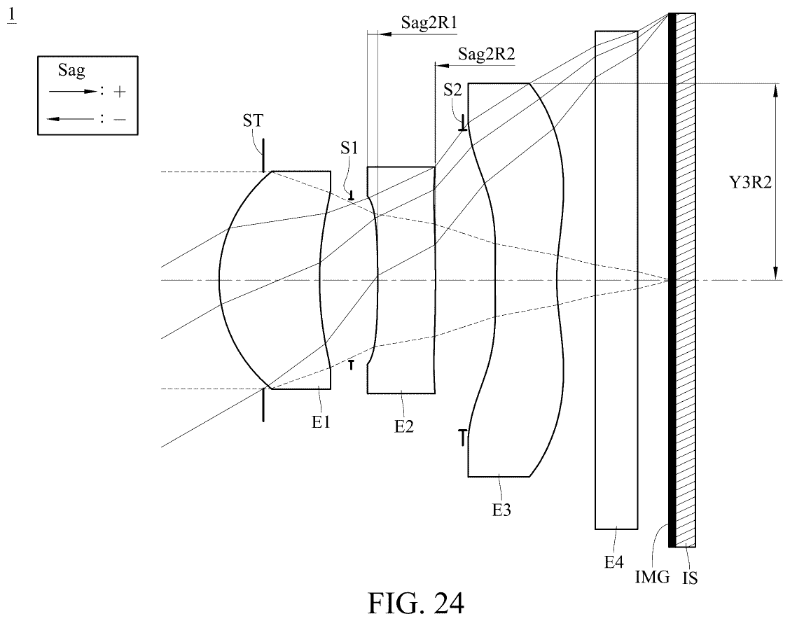

When a maximum effective radius of the image-side surface of the third lens element is Y3R2, and the central thickness of the third lens element is CT3, the following condition can be satisfied: 1.50<Y3R2/CT3<4.00. Therefore, a proper adjustment to the lens thickness of the third lens element and the optical effective radius of the image-side surface of the third lens element is favorable for balancing the travelling direction of light at the image end of the photographing optical lens assembly and reducing incident angle of imaging light onto the image surface. Moreover, the following condition can also be satisfied: 1.80<Y3R2/CT3<3.80. Please refer to FIG. 24, which shows a schematic view of Y3R2 according to the 1st embodiment of the present disclosure.

When a displacement in parallel with an optical axis from an axial vertex on the object-side surface of the second lens element to a maximum effective radius position on the object-side surface of the second lens element is Sag2R1, a displacement in parallel with the optical axis from an axial vertex on the image-side surface of the second lens element to a maximum effective radius position on the image-side surface of the second lens element is Sag2R2, and the central thickness of the second lens element is CT2, the following condition can be satisfied: 0.03<(|Sag2R1|+|Sag2R2|)/CT2<0.25. Therefore, it is favorable for balancing the variation extent of the peripheral lens shape on the object-side surface and the image-side surface of the second lens element so as to mitigate the deflection angle of light for preventing total reflection. Moreover, the following condition can also be satisfied: 0.05<(|Sag2R1|+|Sag2R2|)/CT2<0.22. Please refer to FIG. 24, which shows a schematic view of Sag2R1 and Sag2R2 according to the 1st embodiment of the present disclosure. When the direction from the axial vertex of one surface to the maximum effective radius position of the same surface is facing towards the image side of the photographing optical lens assembly, the value of displacement is positive; when the direction from the axial vertex of the surface to the maximum effective radius position of the same surface is facing towards the object side of the photographing optical lens assembly, the value of displacement is negative.

When a maximum value among central thicknesses of all lens elements of the photographing optical lens assembly is CTmax, and a minimum value among the central thicknesses of all lens elements of the photographing optical lens assembly is CTmin, the following condition can be satisfied: 1.45<CTmax/CTmin<2.20. Therefore, it is favorable for balancing the central thickness configuration of lens elements so as to achieve thinness of the optical lens. Moreover, the following condition can also be satisfied: 1.50<CTmax/CTmin<2.00.

When a curvature radius of the object-side surface of the first lens element is R1, and the central thickness of the first lens element is CT1, the following condition can be satisfied: 1.00<R1/CT1<1.50. Therefore, it is favorable for balancing the curvature radius of the object-side surface of the first lens element and the central thickness of the first lens element, thereby obtaining a proper balance between the control over the travelling direction of the optical path and the reduction in the overall size of the photographing optical lens assembly. Moreover, the following condition can also be satisfied: 1.20<R1/CT1<1.45.

When an axial distance between the object-side surface of the first lens element and the image surface is TL, and a maximum image height of the photographing optical lens assembly (which can be half of a diagonal length of an effective photosensitive area of the image sensor) is ImgH, the following condition can be satisfied: 1.40<TL/ImgH<2.00. Therefore, it is favorable for obtaining a proper balance between the total track length and the image surface size of the photographing optical lens assembly. Moreover, the following condition can also be satisfied: 1.50<TL/ImgH<1.80.

When the entrance pupil diameter of the photographing optical lens assembly is EPD, and the maximum image height of the photographing optical lens assembly is ImgH, the following condition can be satisfied: 0.70<EPD/ImgH<0.90. Therefore, a proper balance between the entrance pupil size and the image height is favorable for adjusting the travelling direction of light, thereby reducing the incident angle onto the image surface and increasing illuminance at the peripheral field of view. Moreover, the following condition can also be satisfied: 0.75<EPD/ImgH<0.86.

When the focal length of the photographing optical lens assembly is f, and the curvature radius of the image-side surface of the third lens element is R6, the following condition can be satisfied: 0.70<f/R6<2.00. Therefore, it is favorable for adjusting the curvature radius of the image-side surface of the third lens element, thereby obtaining a proper balance between the maintenance of the focal length and the reduction in the back focal length. Moreover, the following condition can also be satisfied: 0.90<f/R6<1.80.

When the central thickness of the first lens element is CT1, and the axial distance between the second lens element and the third lens element is T23, the following condition can be satisfied: 1.40<CT1/T23<2.40. Therefore, it is favorable for balancing the central thickness of the first lens element and the lens interval between the second and third lens elements, thereby increasing space utilization and reducing manufacturing tolerance. Moreover, the following condition can also be satisfied: 1.50<CT1/T23<2.10.

When an f-number of the photographing optical lens assembly is FNO, the following condition can be satisfied: 1.80<FNO<2.20. Therefore, it is favorable for obtaining a proper balance between the illuminance and the depth of view, and it is also favorable for increasing the light incident amount to improve image quality. Moreover, the following condition can also be satisfied: 1.90<FNO<2.10.

When half of a maximum field of view of the photographing optical lens assembly is HFOV, the following condition can be satisfied: 26.0 degrees<HFOV<35.0 degrees. Therefore, it is favorable for having sufficient imaging range of the optical lens so as to meet the viewing angle requirements of the applied device. Moreover, the following condition can also be satisfied: 28.0 degrees<HFOV<33.0 degrees.

When the axial distance between the object-side surface of the first lens element and the image surface is TL, the following condition can be satisfied: 0.500 mm (millimeters)<TL<1.800 mm. Therefore, it is favorable for maintaining the total track length so as to achieve thinness of the overall lens. Moreover, the following condition can also be satisfied: 0.800 mm<TL<1.500 mm.

When the focal length of the photographing optical lens assembly is f, the following condition can be satisfied: 0.80 mm<f<1.50 mm. Therefore, a proper configuration of the distance at which light is focused is favorable for satisfying various applications. Moreover, the following condition can also be satisfied: 0.90 mm<f<1.30 mm.

According to the present disclosure, the aforementioned features and conditions can be utilized in numerous combinations so as to achieve corresponding effects.

According to the present disclosure, the lens elements of the photographing optical lens assembly can be made of either glass or plastic material. When the lens elements are made of glass material, the refractive power distribution of the photographing optical lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photographing optical lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the photographing optical lens assembly, based on the corresponding image sensor, can be flat or curved, especially a curved surface being concave facing towards the object side of the photographing optical lens assembly.

According to the present disclosure, an image correction unit, such as a field flattener, can be optionally disposed between the lens element closest to the image side of the photographing optical lens assembly along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

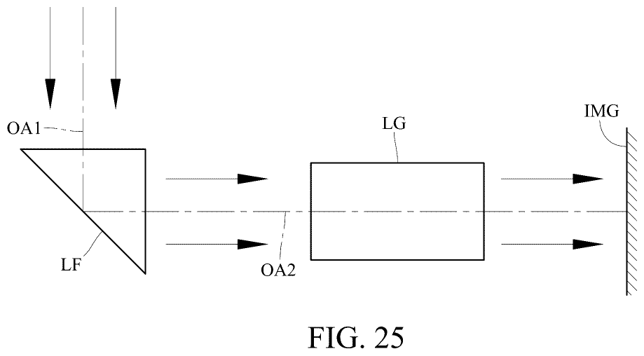

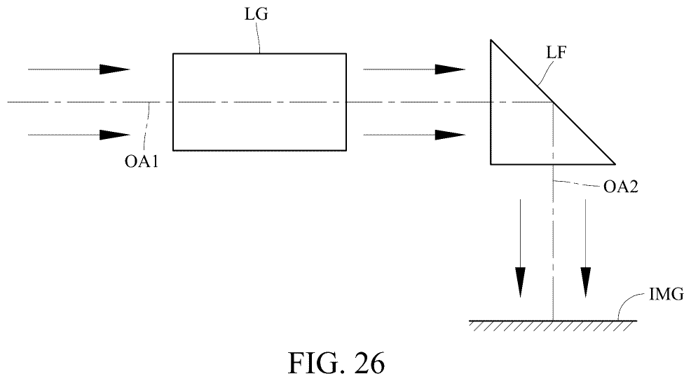

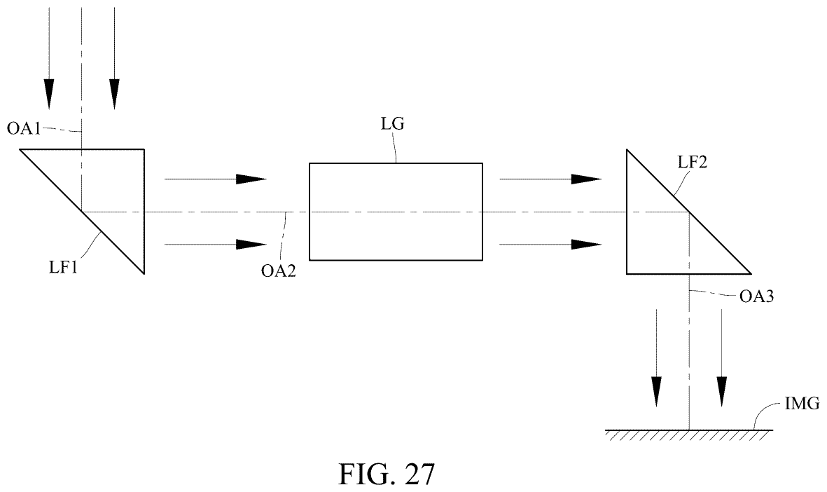

According to the present disclosure, at least one light-folding element, such as a prism or a mirror which can have a surface being planar, spherical, aspheric or in free-form, can be optionally disposed between an imaged object and the image surface on the imaging optical path, such that the photographing optical lens assembly can be more flexible in space arrangement, and therefore the dimensions of an electronic device is not restricted by the total track length of the photographing optical lens assembly. Specifically, please refer to FIG. 25 and FIG. 26. FIG. 25 shows a schematic view of a configuration of a light-folding element in a photographing optical lens assembly according to one embodiment of the present disclosure, and FIG. 26 shows a schematic view of another configuration of a light-folding element in a photographing optical lens assembly according to one embodiment of the present disclosure. In FIG. 25 and FIG. 26, the photographing optical lens assembly can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the photographing optical lens assembly as shown in FIG. 25 or disposed between a lens group LG of the photographing optical lens assembly and the image surface IMG as shown in FIG. 26. Furthermore, please refer to FIG. 27, which shows a schematic view of a configuration of two light-folding elements in a photographing optical lens assembly according to one embodiment of the present disclosure. In FIG. 27, the photographing optical lens assembly can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the photographing optical lens assembly, the second light-folding element LF2 is disposed between the lens group LG of the photographing optical lens assembly and the image surface IMG, and the travelling direction of light on the first optical axis OA1 can be the same direction as the travelling direction of light on the third optical axis OA3 as shown in FIG. 27. The photographing optical lens assembly can be optionally provided with three or more light-folding elements, and the present disclosure is not limited to the type, amount and position of the light-folding elements of the embodiments disclosed in the aforementioned figures.

According to the present disclosure, the photographing optical lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the photographing optical lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the photographing optical lens assembly and thereby provides a wider field of view for the same.

According to the present disclosure, the photographing optical lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photographing optical lens assembly can include one or more optical elements for limiting the form of light passing through the photographing optical lens assembly. Each optical element can be, but not limited to, a filter, a polarizer, etc., and each optical element can be, but not limited to, a single-piece element, a composite component, a thin film, etc. The optical element can be located at the object side or the image side of the photographing optical lens assembly or between any two adjacent lens elements so as to allow light in a specific form to pass through, thereby meeting application requirements.

According to the present disclosure, the photographing optical lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the photographing optical lens assembly can further include a light-blocking element. The light-blocking element can have a non-circular opening, and the non-circular opening can have different effective radii in different directions which are perpendicular to the optical axis. Therefore, it is favorable for coordinating with the shape of non-circular lens elements or aperture stop so as to effectively save the space and make full use of the light passing through said non-circular lens elements or aperture stop, thereby reducing stray light. Moreover, the light-blocking element can be provided with a wavy structure or a jagged structure at a periphery of an inner hole portion thereof.

According to the present disclosure, the object side and the image side are defined in accordance with the direction of the optical axis, and the axial optical data are calculated along the optical axis. Furthermore, if the optical axis is folded by a light-folding element, the axial optical data are also calculated along the folded optical axis.

According to the above description of the present disclosure, the following specific embodiments are provided for further explanation.

### 1st Embodiment

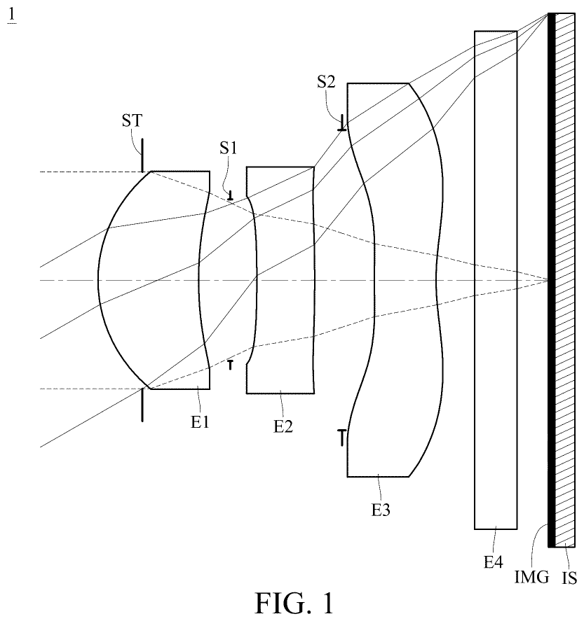

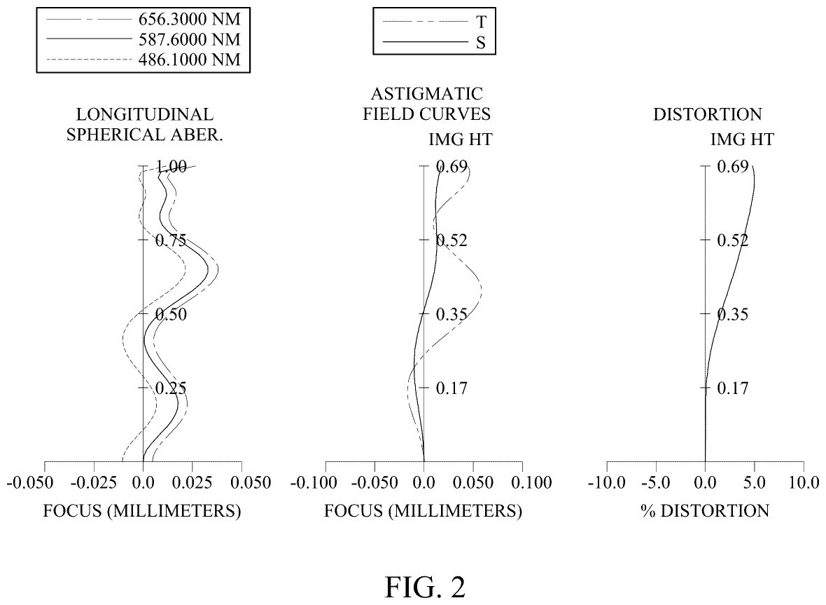

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the photographing optical lens assembly (its reference numeral is omitted) of the present disclosure and an image sensor IS. The photographing optical lens assembly includes, in order from an object side to an image side along an optical axis, an aperture stop ST, a first lens element E1, a stop S1, a second lens element E2, a stop S2, a third lens element E3, a filter E4 and an image surface IMG. The photographing optical lens assembly includes three lens elements (E1, E2 and E3) with no additional lens element disposed between each of the adjacent three lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with negative refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point. The image-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point. The object-side surface of the third lens element E3 has one critical point in an off-axis region thereof. The image-side surface of the third lens element E3 has one critical point in an off-axis region thereof.

The filter E4 is made of glass material and located between the third lens element E3 and the image surface IMG, and will not affect the focal length of the photographing optical lens assembly. The image sensor IS is disposed on or near the image surface IMG of the photographing optical lens assembly.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22 and 24.

In the photographing optical lens assembly of the image capturing unit 1 according to the 1st embodiment, when a focal length of the photographing optical lens assembly is f, an f-number of the photographing optical lens assembly is FNO, and half of a maximum field of view of the photographing optical lens assembly is HFOV, these parameters have the following values: f=1.13 millimeters (mm), FNO=2.00, and HFOV=29.9 degrees (deg.).

When an axial distance between the object-side surface of the first lens element E1 and the image surface IMG is TL, the following condition is satisfied: TL=1.168 mm.

When the axial distance between the object-side surface of the first lens element E1 and the image surface IMG is TL, and a maximum image height of the photographing optical lens assembly is ImgH, the following condition is satisfied: TL/ImgH=1.69.

When an axial distance between the object-side surface of the first lens element E1 and the image-side surface of the third lens element E3 is TD, and an entrance pupil diameter of the photographing optical lens assembly is EPD, the following condition is satisfied: TD/EPD=1.56.

When the entrance pupil diameter of the photographing optical lens assembly is EPD, and the maximum image height of the photographing optical lens assembly is ImgH, the following condition is satisfied: EPD/ImgH=0.82.

When a focal length of the second lens element E2 is f2, and a focal length of the third lens element E3 is f3, the following condition is satisfied: 10×|f3/f2|=1.47.

When the focal length of the photographing optical lens assembly is f, and a curvature radius of the image-side surface of the first lens element E1 is R2, the following condition is satisfied: f/R2=1.27.

When the focal length of the photographing optical lens assembly is f, and a curvature radius of the image-side surface of the third lens element E3 is R6, the following condition is satisfied: f/R6=1.90.

When the focal length of the photographing optical lens assembly is f, a curvature radius of the object-side surface of the second lens element E2 is R3, and a curvature radius of the image-side surface of the second lens element E2 is R4, the following condition is satisfied: |f/R3|+|f/R4|=0.60.

When the curvature radius of the image-side surface of the first lens element E1 is R2, and the curvature radius of the image-side surface of the third lens element E3 is R6, the following condition is satisfied: R2/R6=1.50.

When the curvature radius of the image-side surface of the first lens element E1 is R2, and the curvature radius of the object-side surface of the second lens element E2 is R3, the following condition is satisfied: (R2-R3)/(R2+R3)=−1.90.

When a curvature radius of the object-side surface of the third lens element E3 is R5, and the curvature radius of the image-side surface of the third lens element E3 is R6, the following condition is satisfied: (R5+R6)/(R5−R6)=1.52.

When a curvature radius of the object-side surface of the first lens element E1 is R1, and a central thickness of the first lens element E1 is CT1, the following condition is satisfied: R1/CT1=1.32.

When the central thickness of the first lens element E1 is CT1, and a central thickness of the second lens element E2 is CT2, the following condition is satisfied:

$$CT 1 / CT 2 = 1.74 .$$

When the central thickness of the first lens element E1 is CT1, and an axial distance between the second lens element E2 and the third lens element E3 is T23, the following condition is satisfied: CT1/T23=1.68. In this embodiment, an axial distance between two adjacent lens elements is a distance in a paraxial region between two adjacent lens surfaces of the two adjacent lens elements.

When the axial distance between the second lens element E2 and the third lens element E3 is T23, and a central thickness of the third lens element E3 is CT3, the following condition is satisfied: T23/CT3=0.97.

When the central thickness of the third lens element E3 is CT3, and an axial distance between the first lens element E1 and the second lens element E2 is T12, the following condition is satisfied: CT3/T12=1.06.

When a maximum value among central thicknesses of all lens elements of the photographing optical lens assembly is CTmax, and a minimum value among the central thicknesses of all lens elements of the photographing optical lens assembly is CTmin, the following condition is satisfied: CTmax/CTmin=1.74. In this embodiment, the central thickness of the first lens element E1 is larger than central thicknesses of the other lens elements of the photographing optical lens assembly, and CTmax is equal to the central thickness of the first lens element E1. In this embodiment, the central thickness of the second lens element E2 is smaller than central thicknesses of the other lens elements of the photographing optical lens assembly, and CTmin is equal to the central thickness of the second lens element E2.

When an Abbe number of the second lens element E2 is V2, the following condition is satisfied: V2=18.4.

When the Abbe number of the second lens element E2 is V2, and an Abbe number of the third lens element E3 is V3, the following condition is satisfied: V2+V3=46.7.

When an Abbe number of the first lens element E1 is V1, and a refractive index of the first lens element E1 is N1, the following condition is satisfied: V1/N1=36.51.

When the Abbe number of the second lens element E2 is V2, and a refractive index of the second lens element E2 is N2, the following condition is satisfied: V2/N2=10.91.

When the Abbe number of the third lens element E3 is V3, and a refractive index of the third lens element E3 is N3, the following condition is satisfied: V3/N3=17.83.

When a maximum effective radius of the image-side surface of the third lens element E3 is Y3R2, and the central thickness of the third lens element E3 is CT3, the following condition is satisfied: Y3R2/CT3=3.20.

When a displacement in parallel with the optical axis from an axial vertex on the object-side surface of the second lens element E2 to a maximum effective radius position on the object-side surface of the second lens element E2 is Sag2R1, a displacement in parallel with the optical axis from an axial vertex on the image-side surface of the second lens element E2 to a maximum effective radius position on the image-side surface of the second lens element E2 is Sag2R2, and the central thickness of the second lens element E2 is CT2, the following condition is satisfied: (|Sag2R1|+|Sag2R2|)/CT2=0.18. In this embodiment, the direction of Sag2R1 faces towards the object side of the photographing optical lens assembly, so the value of Sag2R1 is negative. In this embodiment, the direction of Sag2R2 faces towards the object side of the photographing optical lens assembly, so the value of Sag2R2 is negative.

The detailed optical data of the 1st embodiment are shown in Table 1A and the aspheric surface data are shown in Table 1B below.

TABLE 1A
1st Embodiment
f = 1.13 mm, FNO = 2.00, HFOV = 29.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.115 | | | | |
| 2 | Lens 1 | 0.3447 | (ASP) | 0.261 | Plastic | 1.534 | 56.0 | 0.90 |
| 3 | | 0.8900 | (ASP) | 0.082 | | | | |
| 4 | Stop | Plano | | 0.069 | | | | |
| 5 | Lens 2 | −2.8698 | (ASP) | 0.150 | Plastic | 1.686 | 18.4 | −8.89 |
| 6 | | −5.5352 | (ASP) | 0.071 | | | | |
| 7 | Stop | Plano | | 0.084 | | | | |
| 8 | Lens 3 | 2.8939 | (ASP) | 0.160 | Plastic | 1.587 | 28.3 | −1.30 |
| 9 | | 0.5928 | (ASP) | 0.100 | | | | |

| | | | | | | | |
|---|---|---|---|---|---|---|---|
| 10 | Filter | Plano | 0.110 | Glass | 1.517 | 64.2 | — |
| 11 | | Plano | 0.081 | | | | |
| 12 | Image | Plano | — | | | | |

Note:
Reference wavelength is 587.6 nm (d-line).
An effective radius of the stop S1 (Surface 4) is 0.210 mm.
An effective radius of the stop S2 (Surface 7) is 0.390 mm.

TABLE 1B
Aspheric Coefficients

| Surface # | 2 | 3 | 5 |
|---|---|---|---|
| k= | −1.53356E+01 | −8.69652E+01 | −7.57268E+01 |
| A4= | 3.7427271E+01 | 9.3463752E+00 | 3.3105186E+00 |
| A6= | −1.2725337E+03 | 2.1167976E+02 | −2.7938926E+02 |
| A8= | 4.7283731E+04 | −2.8433349E+04 | −1.0083742E+05 |
| A10= | −1.5459301E+06 | 1.0364728E+06 | 1.3379587E+07 |
| A12= | 3.7603563E+07 | −1.8319714E+07 | −7.5086747E+08 |
| A14= | −6.0215005E+08 | 1.5391190E+08 | 2.2726807E+10 |
| A16= | 5.8791561E+09 | −4.8231895E+08 | −3.8537734E+11 |
| A18= | −3.1494459E+10 | — | 3.4275624E+12 |
| A20= | 7.0520129E+10 | — | −1.2397176E+13 |

| Surface # | 6 | 8 | 9 |
|---|---|---|---|
| k= | 0.00000E+00 | −8.84756E+01 | −5.38312E−01 |
| A4= | −6.4073218E+00 | −1.9433485E+01 | −1.7148061E+01 |
| A6= | 6.1552244E+02 | 3.1839269E+02 | 2.5018304E+02 |
| A8= | −3.4268759E+04 | −4.8083694E+03 | −3.6611916E+03 |
| A10= | 1.2022851E+06 | 6.3566210E+04 | 4.3647579E+04 |
| A12= | −2.6131993E+07 | −7.2745421E+05 | −3.9881367E+05 |
| A14= | 3.5512466E+08 | 7.8855244E+06 | 2.6980428E+06 |
| A16= | −2.9497292E+09 | −6.9841764E+07 | −1.3125554E+07 |
| A18= | 1.3700484E+10 | 4.2023134E+08 | 4.4319404E+07 |
| A20= | −2.7198865E+10 | −1.5450411E+09 | −9.8160393E+07 |
| A22= | — | 3.1097386E+09 | 1.2776253E+08 |
| A24= | — | −2.6201982E+09 | −7.3760796E+07 |

In Table 1A, the curvature radius, the thickness and the focal length are shown in millimeters (mm). Surface numbers 0-12 represent the surfaces sequentially arranged from the object side to the image side along the optical axis. In Table 1B, k represents the conic coefficient of the equation of the aspheric surface profiles. A4-A24 represent the aspheric coefficients ranging from the 4th order to the 24th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

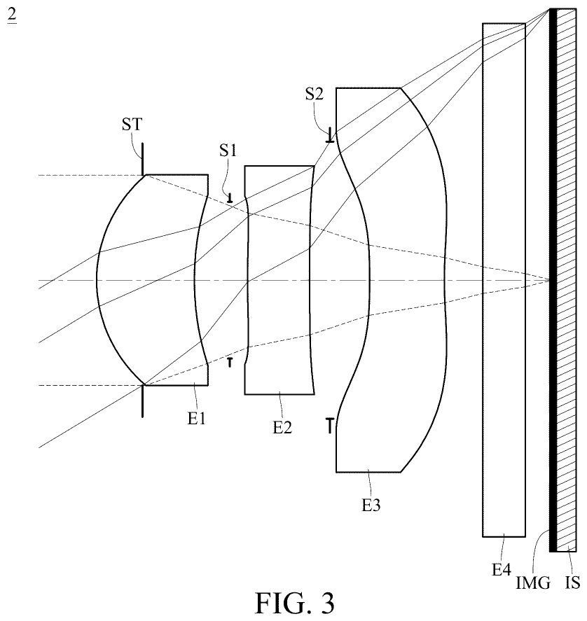

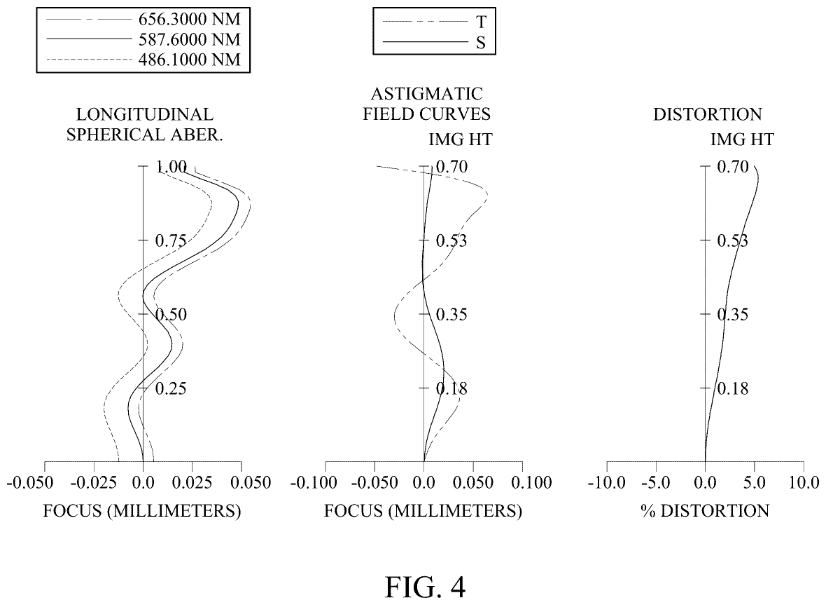

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the photographing optical lens assembly (its reference numeral is omitted) of the present disclosure and an image sensor IS. The photographing optical lens assembly includes, in order from an object side to an image side along an optical axis, an aperture stop ST, a first lens element E1, a stop S1, a second lens element E2, a stop S2, a third lens element E3, a filter E4 and an image surface IMG. The photographing optical lens assembly includes three lens elements (E1, E2 and E3) with no additional lens element disposed between each of the adjacent three lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The image-side surface of the third lens element E3 has one critical point in an off-axis region thereof.

The filter E4 is made of glass material and located between the third lens element E3 and the image surface IMG, and will not affect the focal length of the photographing optical lens assembly. The image sensor IS is disposed on or near the image surface IMG of the photographing optical lens assembly.

The detailed optical data of the 2nd embodiment are shown in Table 2A and the aspheric surface data are shown in Table 2B below.

TABLE 2A
2nd Embodiment
f = 1.09 mm, FNO = 2.00, HFOV = 31.1 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.119 | | | | |
| 2 | Lens 1 | 0.3519 | (ASP) | 0.254 | Plastic | 1.534 | 55.9 | 1.02 |
| 3 | | 0.7421 | (ASP) | 0.092 | | | | |
| 4 | Stop | Plano | | 0.046 | | | | |
| 5 | Lens 2 | 2.0500 | (ASP) | 0.161 | Plastic | 1.656 | 21.3 | 5.18 |
| 6 | | 5.0000 | (ASP) | 0.053 | | | | |
| 7 | Stop | Plano | | 0.103 | | | | |
| 8 | Lens 3 | −2.5347 | (ASP) | 0.194 | Plastic | 1.614 | 25.6 | −1.21 |
| 9 | | 1.0816 | (ASP) | 0.100 | | | | |

| | | | | | | | |
|---|---|---|---|---|---|---|---|
| 10 | Filter | Plano | 0.110 | Glass | 1.517 | 64.2 | — |
| 11 | | Plano | 0.064 | | | | |
| 12 | Image | Plano | — | | | | |

Note:
Reference wavelength is 587.6 nm (d-line).
An effective radius of the stop S1 (Surface 4) is 0.204 mm.
An effective radius of the stop S2 (Surface 7) is 0.360 mm.

TABLE 2B
Aspheric Coefficients

| Surface # | 2 | 3 | 5 |
|---|---|---|---|
| k= | −1.56497E+01 | −5.50369E+01 | 3.66445E+01 |
| A4= | 5.0751080E+01 | 1.6027375E+01 | −3.0252905E+01 |
| A6= | −3.1293250E+03 | −6.1582382E+02 | 5.5832851E+03 |
| A8= | 1.6937724E+05 | 2.6444142E+04 | −6.1441802E+05 |
| A10= | −6.1010483E+06 | −7.6553479E+05 | 3.8944111E+07 |
| A12= | 1.4191532E+08 | 1.2879004E+07 | −1.5155247E+09 |
| A14= | −2.1015513E+09 | −1.1983740E+08 | 3.6566305E+10 |
| A16= | 1.9084994E+10 | 4.7987650E+08 | −5.3039965E+11 |
| A18= | −9.6574495E+10 | — | 4.2061482E+12 |
| A20= | 2.0768035E+11 | — | −1.3926914E+13 |

| Surface # | 6 | 8 | 9 |
|---|---|---|---|
| k= | −9.00000E+01 | −2.16991E+01 | 1.28530E+00 |
| A4= | −7.5490835E+00 | −1.7553639E+01 | −1.3588332E+01 |
| A6= | 6.0555861E+02 | 3.0471359E+02 | 2.1778866E+02 |
| A8= | −2.5568345E+04 | −3.1710670E+03 | −3.3781096E+03 |
| A10= | 6.4513137E+05 | −5.1244209E+04 | 3.6735161E+04 |
| A12= | −9.2518510E+06 | 2.6770717E+06 | −2.6592761E+05 |
| A14= | 6.8101463E+07 | −4.6996308E+07 | 1.2494048E+06 |
| A16= | −1.5755472E+08 | 4.6215711E+08 | −3.6246112E+06 |
| A18= | −7.7271341E+08 | −2.7743617E+09 | 5.7658276E+06 |
| A20= | 3.7090325E+09 | 1.0102388E+10 | −3.4673490E+06 |
| A22= | — | −2.0530809E+10 | −8.2221618E+05 |
| A24= | — | 1.7881691E+10 | — |

In the 2nd embodiment, the equation of the aspheric surface profiles of the aforementioned lens elements is the same as the equation of the 1st embodiment. Also, the definitions of these parameters shown in Table 2C are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
Schematic Parameters

| | | | |
|---|---|---|---|
| f [mm] | 1.09 | R1/CT1 | 1.39 |
| FNO | 2.00 | CT1/CT2 | 1.58 |
| HFOV [deg.] | 31.1 | CT1/T23 | 1.63 |
| TL [mm] | 1.177 | T23/CT3 | 0.80 |
| TL/ImgH | 1.67 | CT3/T12 | 1.41 |
| TD/EPD | 1.65 | CTmax/CTmin | 1.58 |
| EPD/ImgH | 0.78 | V2 | 21.3 |
| 10 × \|f3/f2\| | 2.33 | V2 + V3 | 46.9 |
| f/R2 | 1.47 | V1/N1 | 36.44 |
| f/R6 | 1.01 | V2/N2 | 12.86 |
| \|f/R3\| + \|f/R4\| | 0.75 | V3/N3 | 15.86 |
| R2/R6 | 0.69 | Y3R2/CT3 | 2.57 |
| (R2 − R3)/(R2 + R3) | −0.47 | (\|Sag2R1\| + \|Sag2R2\|)/CT2 | 0.12 |
| (R5 + R6)/(R5 − R6) | 0.40 | — | — |

### 3rd Embodiment

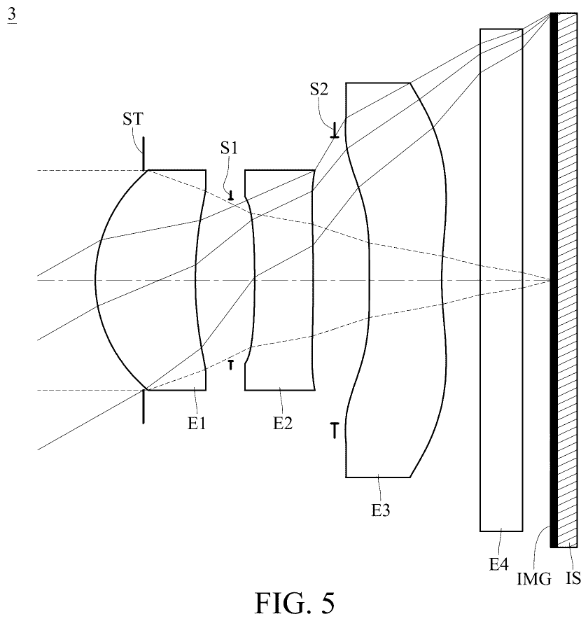

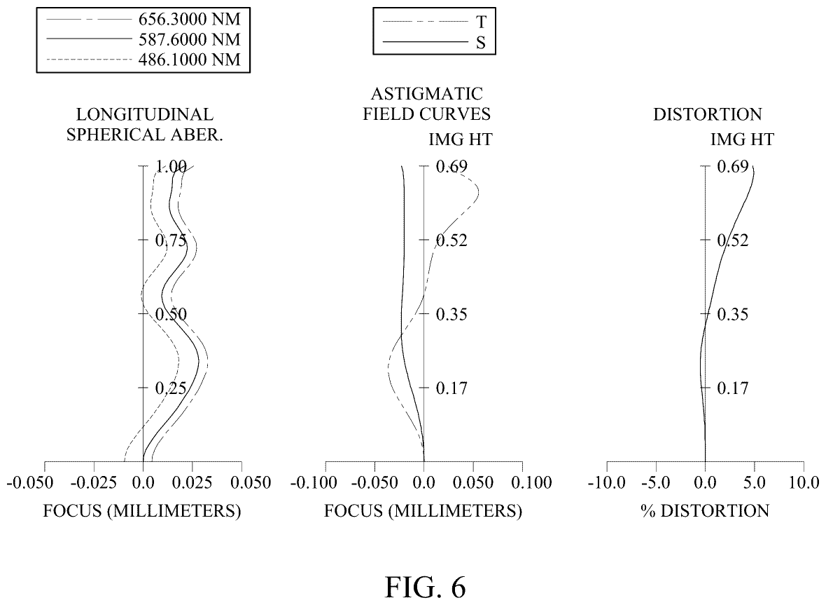

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the photographing optical lens assembly (its reference numeral is omitted) of the present disclosure and an image sensor IS. The photographing optical lens assembly includes, in order from an object side to an image side along an optical axis, an aperture stop ST, a first lens element E1, a stop S1, a second lens element E2, a stop S2, a third lens element E3, a filter E4 and an image surface IMG. The photographing optical lens assembly includes three lens elements (E1, E2 and E3) with no additional lens element disposed between each of the adjacent three lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with negative refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has two inflection points. The image-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has two inflection points. The object-side surface of the third lens element E3 has two critical points in an off-axis region thereof. The image-side surface of the third lens element E3 has one critical point in an off-axis region thereof.

The filter E4 is made of glass material and located between the third lens element E3 and the image surface IMG, and will not affect the focal length of the photographing optical lens assembly. The image sensor IS is disposed on or near the image surface IMG of the photographing optical lens assembly.

The detailed optical data of the 3rd embodiment are shown in Table 3A and the aspheric surface data are shown in Table 3B below.

TABLE 3A
3rd Embodiment
f = 1.14 mm, FNO = 2.00, HFOV = 29.6 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.125 | | | | |
| 2 | Lens 1 | 0.3548 | (ASP) | 0.260 | Plastic | 1.544 | 56.0 | 0.87 |
| 3 | | 1.0654 | (ASP) | 0.092 | | | | |
| 4 | Stop | Plano | | 0.062 | | | | |
| 5 | Lens 2 | −2.6877 | (ASP) | 0.152 | Plastic | 1.686 | 18.4 | −4.11 |
| 6 | | −59.3116 | (ASP) | 0.056 | | | | |
| 7 | Stop | Plano | | 0.090 | | | | |
| 8 | Lens 3 | 11.1718 | (ASP) | 0.188 | Plastic | 1.587 | 28.3 | −1.38 |
| 9 | | 0.7528 | (ASP) | 0.100 | | | | |

| | | | | | | | |
|---|---|---|---|---|---|---|---|
| 10 | Filter | Plano | 0.110 | Glass | 1.517 | 64.2 | — |
| 11 | | Plano | 0.073 | | | | |
| 12 | Image | Plano | — | | | | |

Note:
Reference wavelength is 587.6 nm (d-line).
An effective radius of the stop S1 (Surface 4) is 0.210 mm.
An effective radius of the stop S2 (Surface 7) is 0.372 mm.

TABLE 3B
Aspheric Coefficients

| Surface # | 2 | 3 | 5 |
|---|---|---|---|
| k= | −1.63729E+01 | −6.43218E+01 | 5.21565E+01 |
| A4= | 4.3895005E+01 | 1.5755385E+01 | −8.3023442E+00 |
| A6= | −2.1397962E+03 | −9.9995906E+02 | 2.4012205E+03 |
| A8= | 9.7143977E+04 | 4.6895177E+04 | −3.7173992E+05 |
| A10= | −3.0968608E+06 | −1.3366577E+06 | 2.8738476E+07 |
| A12= | 6.5547374E+07 | 2.1849654E+07 | −1.2781440E+09 |
| A14= | −8.9372598E+08 | −1.9093908E+08 | 3.3959526E+10 |
| A16= | 7.5070500E+09 | 6.8738923E+08 | −5.3065669E+11 |
| A18= | −3.5190861E+10 | — | 4.4737831E+12 |
| A20= | 7.0110301E+10 | — | −1.5619643E+13 |

| Surface # | 6 | 8 | 9 |
|---|---|---|---|
| k= | −4.18776E+01 | 9.90000E+01 | 4.35980E−02 |
| A4= | −1.7031339E+01 | −2.1008102E+01 | −1.4707365E+01 |
| A6= | 1.5862312E+03 | 5.5396784E+02 | 1.8589173E+02 |
| A8= | −8.3492478E+04 | −1.5202579E+04 | −1.8318841E+03 |
| A10= | 2.6324936E+06 | 3.0715539E+05 | 6.4829091E+03 |
| A12= | −4.9866692E+07 | −4.0627948E+06 | 8.1505168E+04 |
| A14= | 5.6705931E+08 | 3.5432283E+07 | −1.3070462E+06 |
| A16= | −3.7161227E+09 | −2.0241381E+08 | 8.8217033E+06 |
| A18= | 1.2498389E+10 | 7.2700935E+08 | −3.4454039E+07 |
| A20= | −1.5612144E+10 | −1.4850473E+09 | 8.0364697E+07 |
| A22= | — | 1.3125905E+09 | −1.0396948E+08 |
| A24= | — | — | 5.7370845E+07 |

In the 3rd embodiment, the equation of the aspheric surface profiles of the aforementioned lens elements is the same as the equation of the 1st embodiment. Also, the definitions of these parameters shown in Table 3C are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Schematic Parameters

| | | | |
|---|---|---|---|
| f[mm] | 1.14 | R1/CT1 | 1.36 |
| FNO | 2.00 | CT1/CT2 | 1.71 |
| HFOV [deg.] | 29.6 | CT1/T23 | 1.78 |
| TL [mm] | 1.183 | T23/CT3 | 0.78 |
| TL/ImgH | 1.71 | CT3/T12 | 1.22 |
| TD/EPD | 1.58 | CTmax/CTmin | 1.71 |
| EPD/ImgH | 0.83 | V2 | 18.4 |
| 10 × \|f3/f2\| | 3.37 | V2 + V3 | 46.7 |
| f/R2 | 1.07 | V1/N1 | 36.27 |
| f/R6 | 1.52 | V2/N2 | 10.91 |
| \|f/R3\| + \|f/R4\| | 0.44 | V3/N3 | 17.83 |
| R2/R6 | 1.42 | Y3R2/CT3 | 2.73 |
| (R2 − R3)/(R2 + R3) | −2.31 | (\|Sag2R1\| + \|Sag2R2\|)/CT2 | 0.19 |
| (R5 + R6)/(R5 − R6) | 1.14 | — | — |

### 4th Embodiment

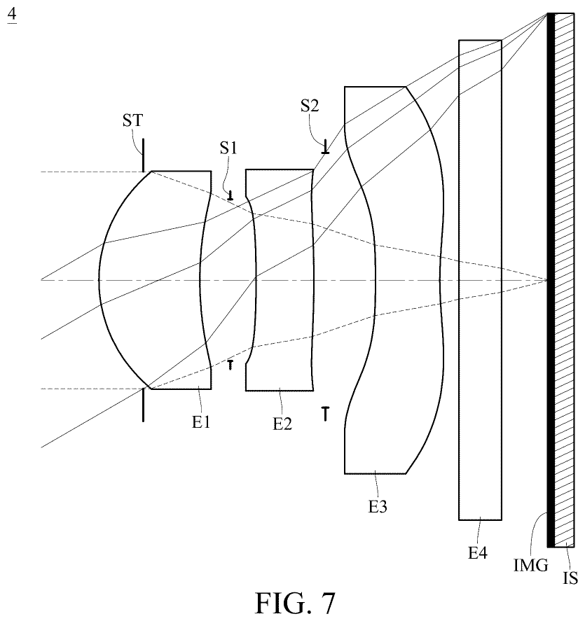

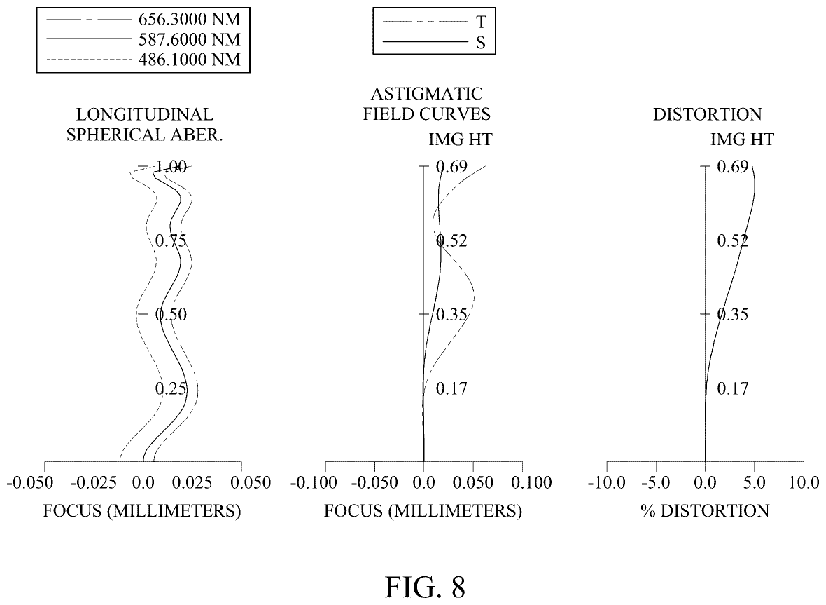

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the photographing optical lens assembly (its reference numeral is omitted) of the present disclosure and an image sensor IS. The photographing optical lens assembly includes, in order from an object side to an image side along an optical axis, an aperture stop ST, a first lens element E1, a stop S1, a second lens element E2, a stop S2, a third lens element E3, a filter E4 and an image surface IMG. The photographing optical lens assembly includes three lens elements (E1, E2 and E3) with no additional lens element disposed between each of the adjacent three lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with negative refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point. The image-side surface of the second lens element E2 has one critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The filter E4 is made of glass material and located between the third lens element E3 and the image surface IMG, and will not affect the focal length of the photographing optical lens assembly. The image sensor IS is disposed on or near the image surface IMG of the photographing optical lens assembly.

The detailed optical data of the 4th embodiment are shown in Table 4A and the aspheric surface data are shown in Table 4B below.

TABLE 4A
4th Embodiment
f = 1.12 mm, FNO = 1.99, HFOV = 30.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.115 | | | | |
| 2 | Lens 1 | 0.3465 | (ASP) | 0.262 | Plastic | 1.545 | 56.1 | 0.91 |
| 3 | | 0.8482 | (ASP) | 0.079 | | | | |
| 4 | Stop | Plano | | 0.067 | | | | |
| 5 | Lens 2 | −3.0515 | (ASP) | 0.150 | Plastic | 1.669 | 19.5 | −108.48 |
| 6 | | −3.2482 | (ASP) | 0.030 | | | | |
| 7 | Stop | Plano | | 0.130 | | | | |
| 8 | Lens 3 | −3.8020 | (ASP) | 0.167 | Plastic | 1.566 | 37.4 | −1.19 |
| 9 | | 0.8309 | (ASP) | 0.050 | | | | |

| | | | | | | | |
|---|---|---|---|---|---|---|---|
| 10 | Filter | Plano | 0.110 | Glass | 1.517 | 64.2 | — |
| 11 | | Plano | 0.120 | | | | |
| 12 | Image | Plano | — | | | | |

Note:
Reference wavelength is 587.6 nm (d-line).
An effective radius of the stop S1 (Surface 4) is 0.210 mm.
An effective radius of the stop S2 (Surface 7) is 0.331 mm.

TABLE 4B
Aspheric Coefficients

| Surface # | 2 | 3 | 5 |
|---|---|---|---|
| k= | −1.60691E+01 | −9.00000E+01 | −8.53712E+01 |
| A4= | 4.0249223E+01 | 1.1620895E+01 | −9.1463905E+00 |
| A6= | −1.6427991E+03 | 7.1995108E+01 | 1.7829099E+03 |
| A8= | 7.1138211E+04 | −2.8742324E+04 | −2.7922862E+05 |
| A10= | −2.4008720E+06 | 1.3271398E+06 | 2.2635041E+07 |
| A12= | 5.5923516E+07 | −2.8084344E+07 | −1.0520774E+09 |
| A14= | −8.4271375E+08 | 2.8050412E+08 | 2.8909032E+10 |
| A16= | 7.7748713E+09 | −1.0663937E+09 | −4.6321662E+11 |
| A18= | −3.9710876E+10 | — | 3.9784542E+12 |
| A20= | 8.5548590E+10 | — | −1.4079870E+13 |

| Surface # | 6 | 8 | 9 |
|---|---|---|---|
| k= | 0.00000E+00 | −8.92568E+01 | 2.43626E−01 |
| A4= | −9.8949895E+00 | −1.8957530E+01 | −1.5043317E+01 |
| A6= | 1.1835904E+03 | 4.9240016E+02 | 2.6933949E+02 |
| A8= | −7.0574005E+04 | −1.3507176E+04 | −5.0229183E+03 |
| A10= | 2.5211003E+06 | 2.6335457E+05 | 6.9815564E+04 |
| A12= | −5.5393380E+07 | −3.3199646E+06 | −6.8244364E+05 |
| A14= | 7.5835677E+08 | 2.8121393E+07 | 4.6480294E+06 |
| A16= | −6.3043578E+09 | −1.6363799E+08 | −2.1871571E+07 |
| A18= | 2.9084153E+10 | 6.4855868E+08 | 6.9651406E+07 |
| A20= | −5.7015237E+10 | −1.6754600E+09 | −1.4357180E+08 |
| A22= | — | 2.5435522E+09 | 1.7358120E+08 |
| A24= | — | −1.7207233E+09 | −9.3894313E+07 |

In the 4th embodiment, the equation of the aspheric surface profiles of the aforementioned lens elements is the same as the equation of the 1st embodiment. Also, the definitions of these parameters shown in Table 4C are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
Schematic Parameters

| | | | |
|---|---|---|---|
| f [mm] | 1.12 | R1/CT1 | 1.32 |
| FNO | 1.99 | CT1/CT2 | 1.75 |
| HFOV [deg.] | 30.0 | CT1/T23 | 1.64 |
| TL [mm] | 1.165 | T23/CT3 | 0.96 |
| TL/ImgH | 1.69 | CT3/T12 | 1.14 |
| TD/EPD | 1.57 | CTmax/CTmin | 1.75 |
| EPD/ImgH | 0.82 | V2 | 19.5 |
| 10 × \|f3/f2\| | 0.11 | V2 + V3 | 56.9 |
| f/R2 | 1.32 | V1/N1 | 36.31 |
| f/R6 | 1.35 | V2/N2 | 11.68 |
| \|f/R3\| + \|f/R4\| | 0.71 | V3/N3 | 23.88 |
| R2/R6 | 1.02 | Y3R2/CT3 | 3.01 |
| (R2 − R3)/(R2 + R3) | −1.77 | (\|Sag2R1\| + \|Sag2R2\|)/CT2 | 0.19 |
| (R5 + R6)/(R5 − R6) | 0.64 | — | — |

### 5th Embodiment

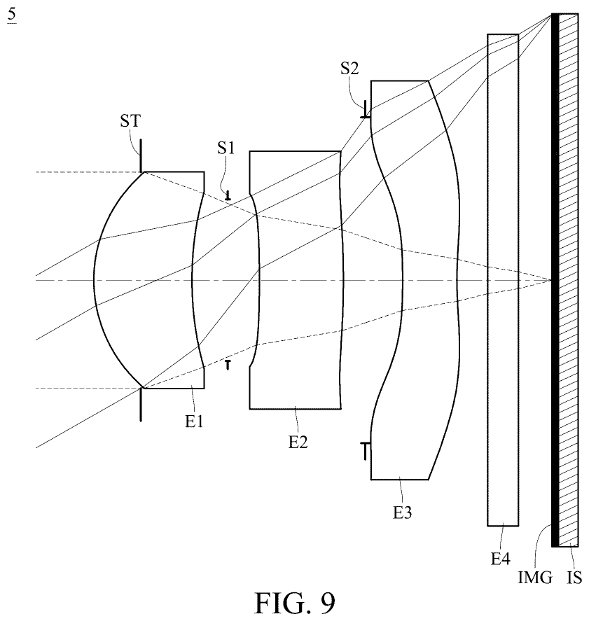

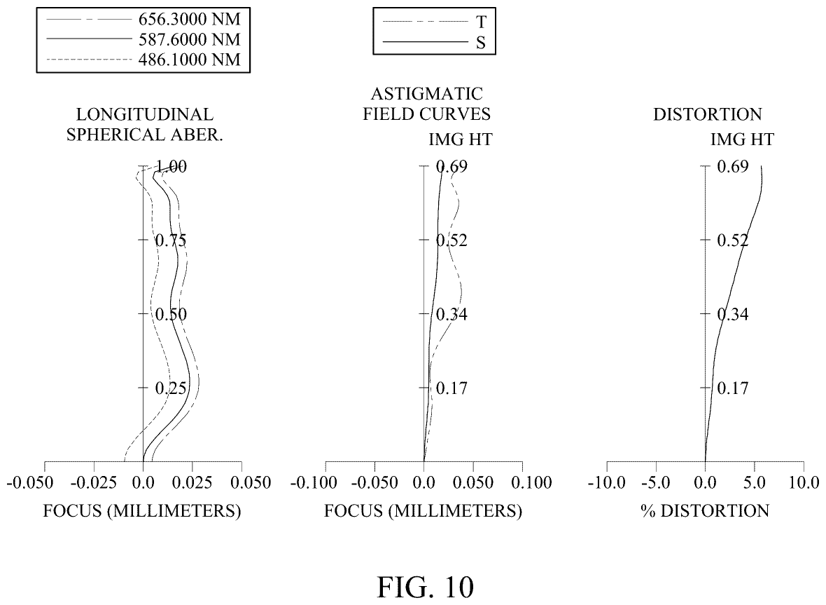

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the photographing optical lens assembly (its reference numeral is omitted) of the present disclosure and an image sensor IS. The photographing optical lens assembly includes, in order from an object side to an image side along an optical axis, an aperture stop ST, a first lens element E1, a stop S1, a second lens element E2, a stop S2, a third lens element E3, a filter E4 and an image surface IMG. The photographing optical lens assembly includes three lens elements (E1, E2 and E3) with no additional lens element disposed between each of the adjacent three lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point. The image-side surface of the second lens element E2 has one critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The filter E4 is made of glass material and located between the third lens element E3 and the image surface IMG, and will not affect the focal length of the photographing optical lens assembly. The image sensor IS is disposed on or near the image surface IMG of the photographing optical lens assembly.

The detailed optical data of the 5th embodiment are shown in Table 5A and the aspheric surface data are shown in Table 5B below.

TABLE 5A
5th Embodiment
f = 1.12 mm, FNO = 2.00, HFOV = 29.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.122 | | | | |
| 2 | Lens 1 | 0.3569 | (ASP) | 0.255 | Plastic | 1.545 | 56.1 | 0.93 |
| 3 | | 0.9043 | (ASP) | 0.093 | | | | |
| 4 | Stop | Plano | | 0.082 | | | | |
| 5 | Lens 2 | −3.7372 | (ASP) | 0.218 | Plastic | 1.697 | 16.3 | 14.04 |
| 6 | | −2.7693 | (ASP) | 0.057 | | | | |
| 7 | Stop | Plano | | 0.097 | | | | |
| 8 | Lens 3 | −2.8192 | (ASP) | 0.141 | Plastic | 1.660 | 20.4 | −1.05 |
| 9 | | 0.9344 | (ASP) | 0.080 | | | | |

| | | | | | | | |
|---|---|---|---|---|---|---|---|
| 10 | Filter | Plano | 0.080 | Glass | 1.517 | 64.2 | — |
| 11 | | Plano | 0.087 | | | | |
| 12 | Image | Plano | — | | | | |

Note:
Reference wavelength is 587.6 nm (d-line).
An effective radius of the stop S1 (Surface 4) is 0.210 mm.
An effective radius of the stop S2 (Surface 7) is 0.423 mm.

TABLE 5B
Aspheric Coefficients

| Surface # | 2 | 3 | 5 |
|---|---|---|---|
| k= | −1.60329E+01 | −6.63864E+01 | −2.51792E+01 |
| A4= | 3.8855409E+01 | 1.1403350E+01 | −7.6307216E+00 |
| A6= | −1.5626850E+03 | −3.1067450E+02 | 1.4053568E+03 |
| A8= | 6.3503378E+04 | 9.2954041E+03 | −1.9560957E+05 |
| A10= | −1.9827001E+06 | −2.2103389E+05 | 1.4260860E+07 |
| A12= | 4.3525436E+07 | 3.4914606E+06 | −6.0704391E+08 |
| A14= | −6.3208045E+08 | −3.2491064E+07 | 1.5464049E+10 |
| A16= | 5.7078040E+09 | 1.2582923E+08 | −2.3126986E+11 |
| A18= | −2.8767098E+10 | — | 1.8591330E+12 |
| A20= | 6.1314250E+10 | — | −6.1612247E+12 |

| Surface # | 6 | 8 | 9 |
|---|---|---|---|
| k= | 3.98844E+01 | −8.73977E+01 | 1.11658E+00 |
| A4= | −5.2168961E+00 | −2.2060462E+01 | −1.6085746E+01 |
| A6= | 4.3082097E+02 | 6.2987171E+02 | 2.6187723E+02 |
| A8= | −1.7936352E+04 | −1.5954991E+04 | −3.7171884E+03 |
| A10= | 4.5762333E+05 | 2.7737380E+05 | 3.7326808E+04 |
| A12= | −7.0003900E+06 | −3.1061877E+06 | −2.5679337E+05 |
| A14= | 6.5008965E+07 | 2.3269481E+07 | 1.1961558E+06 |
| A16= | −3.6087703E+08 | −1.1997184E+08 | −3.5978158E+06 |
| A18= | 1.1053127E+09 | 4.2517870E+08 | 6.0780626E+06 |
| A20= | −1.4415530E+09 | −9.9435685E+08 | −2.8861137E+06 |
| A22= | — | 1.3807313E+09 | −6.6278341E+06 |
| A24= | — | −8.5850379E+08 | 8.0758974E+06 |

In the 5th embodiment, the equation of the aspheric surface profiles of the aforementioned lens elements is the same as the equation of the 1st embodiment. Also, the definitions of these parameters shown in Table 5C are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Schematic Parameters

| | | | |
|---|---|---|---|
| f [mm] | 1.12 | R1/CT1 | 1.40 |
| FNO | 2.00 | CT1/CT2 | 1.17 |
| HFOV [deg.] | 29.7 | CT1/T23 | 1.66 |
| TL [mm] | 1.190 | T23/CT3 | 1.09 |
| TL/ImgH | 1.72 | CT3/T12 | 0.81 |
| TD/EPD | 1.68 | CTmax/CTmin | 1.81 |
| EPD/ImgH | 0.81 | V2 | 16.3 |
| 10 × \|f3/f2\| | 0.75 | V2 + V3 | 36.7 |
| f/R2 | 1.24 | V1/N1 | 36.31 |
| f/R6 | 1.20 | V2/N2 | 9.61 |
| \|f/R3\| + \|f/R4\| | 0.71 | V3/N3 | 12.29 |
| R2/R6 | 0.97 | Y3R2/CT3 | 3.68 |
| (R2 − R3)/(R2 + R3) | −1.64 | (\|Sag2R1\| + \|Sag2R2\|)/CT2 | 0.14 |
| (R5 + R6)/(R5 − R6) | 0.50 | — | — |

### 6th Embodiment

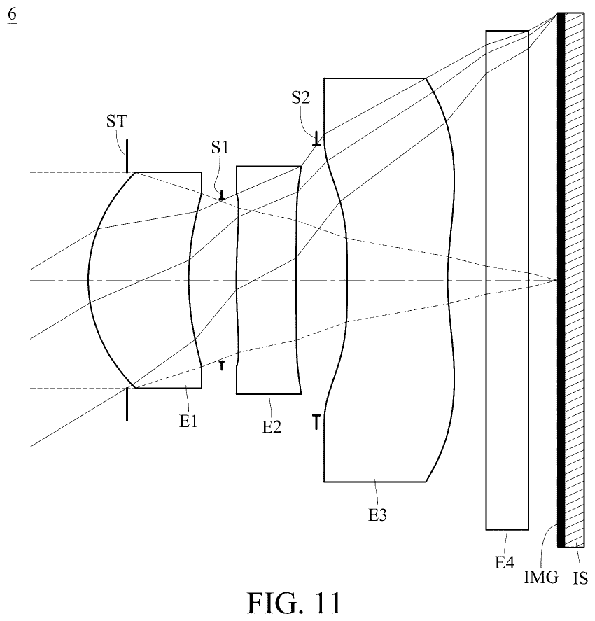

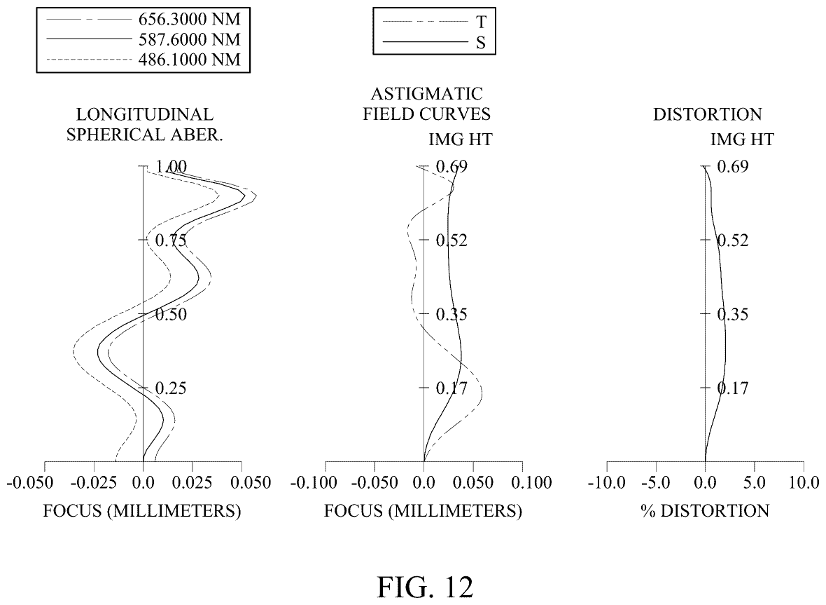

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the photographing optical lens assembly (its reference numeral is omitted) of the present disclosure and an image sensor IS. The photographing optical lens assembly includes, in order from an object side to an image side along an optical axis, an aperture stop ST, a first lens element E1, a stop S1, a second lens element E2, a stop S2, a third lens element E3, a filter E4 and an image surface IMG. The photographing optical lens assembly includes three lens elements (E1, E2 and E3) with no additional lens element disposed between each of the adjacent three lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point. The object-side surface of the second lens element E2 has one critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The filter E4 is made of glass material and located between the third lens element E3 and the image surface IMG, and will not affect the focal length of the photographing optical lens assembly. The image sensor IS is disposed on or near the image surface IMG of the photographing optical lens assembly.

The detailed optical data of the 6th embodiment are shown in Table 6A and the aspheric surface data are shown in Table 6B below.

TABLE 6A
6th Embodiment
f = 1.12 mm, FNO = 2.00, HFOV = 31.3 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.101 | | | | |
| 2 | Lens 1 | 0.3439 | (ASP) | 0.261 | Plastic | 1.544 | 56.0 | 1.18 |
| 3 | | 0.5441 | (ASP) | 0.086 | | | | |
| 4 | Stop | Plano | | 0.038 | | | | |
| 5 | Lens 2 | 1.5382 | (ASP) | 0.155 | Plastic | 1.669 | 19.5 | 2.84 |
| 6 | | 7.7809 | (ASP) | 0.053 | | | | |
| 7 | Stop | Plano | | 0.080 | | | | |
| 8 | Lens 3 | −99.1908 | (ASP) | 0.261 | Plastic | 1.639 | 23.5 | −1.13 |
| 9 | | 0.7301 | (ASP) | 0.100 | | | | |

| | | | | | | | |
|---|---|---|---|---|---|---|---|
| 10 | Filter | Plano | 0.110 | Glass | 1.517 | 64.2 | — |
| 11 | | Plano | 0.076 | | | | |
| 12 | Image | Plano | — | | | | |

Note:
Reference wavelength is 587.6 nm (d-line).
An effective radius of the stop S1 (Surface 4) is 0.211 mm.
An effective radius of the stop S2 (Surface 7) is 0.351 mm.

TABLE 6B
Aspheric Coefficients

| Surface # | 2 | 3 | 5 |
|---|---|---|---|
| k= | −1.72534E+01 | −7.03905E+01 | −9.00000E+01 |
| A4= | 3.1300522E+01 | −9.0988006E+00 | −1.3714170E+01 |
| A6= | −6.9293120E+02 | 3.0511883E+03 | 3.3053120E+03 |
| A8= | 9.7251984E+03 | −2.0106561E+05 | −4.0401573E+05 |
| A10= | −3.6371788E+04 | 6.5587923E+06 | 2.7065100E+07 |
| A12= | −7.4125717E+04 | −1.1575782E+08 | −1.0782668E+09 |
| A14= | −2.1718610E+07 | 1.0455036E+09 | 2.6024544E+10 |
| A16= | 5.1079377E+08 | −3.7642350E+09 | −3.7136018E+11 |
| A18= | −4.1822558E+09 | — | 2.8635219E+12 |
| A20= | 1.1881957E+10 | — | −9.1480427E+12 |

| Surface # | 6 | 8 | 9 |
|---|---|---|---|
| k= | −9.00000E+01 | 9.00000E+01 | 1.15666E−01 |
| A4= | −1.3362997E+00 | −2.2539027E+01 | −1.1555960E+01 |
| A6= | 1.0105292E+02 | 8.3250324E+02 | 1.2780572E+02 |
| A8= | −4.4074692E+03 | −3.2893902E+04 | −1.0795651E+03 |
| A10= | 1.5244418E+04 | 9.4492769E+05 | −5.2523383E+02 |
| A12= | 4.9585604E+06 | −1.8427147E+07 | 1.3996575E+05 |
| A14= | −1.5238892E+08 | 2.4471996E+08 | −1.7655067E+06 |
| A16= | 1.9580962E+09 | −2.1928280E+09 | 1.1542080E+07 |
| A18= | −1.1890257E+10 | 1.2946477E+10 | −4.4866488E+07 |
| A20= | 2.7994930E+10 | −4.8010572E+10 | 1.0402820E+08 |
| A22= | — | 1.0096261E+11 | −1.3275514E+08 |
| A24= | — | −9.1560985E+10 | 7.1683713E+07 |

In the 6th embodiment, the equation of the aspheric surface profiles of the aforementioned lens elements is the same as the equation of the 1st embodiment. Also, the definitions of these parameters shown in Table 6C are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Schematic Parameters

| | | | |
|---|---|---|---|
| f[mm] | 1.12 | R1/CT1 | 1.32 |
| FNO | 2.00 | CT1/CT2 | 1.68 |
| HFOV [deg.] | 31.3 | CT1/T23 | 1.96 |
| TL [mm] | 1.220 | T23/CT3 | 0.51 |
| TL/ImgH | 1.77 | CT3/T12 | 2.10 |
| TD/EPD | 1.67 | CTmax/CTmin | 1.68 |
| EPD/ImgH | 0.81 | V2 | 19.5 |
| 10 × \|f3/f2\| | 3.99 | V2 + V3 | 43.0 |
| f/R2 | 2.06 | V1/N1 | 36.27 |
| f/R6 | 1.53 | V2/N2 | 11.68 |
| \|f/R3\| + \|f/R4\| | 0.87 | V3/N3 | 14.34 |
| R2/R6 | 0.75 | Y3R2/CT3 | 2.01 |
| (R2 − R3)/(R2 + R3) | −0.48 | (\|Sag2R1\| + \|Sag2R2\|)/CT2 | 0.09 |
| (R5 + R6)/(R5 − R6) | 0.99 | — | — |

### 7th Embodiment

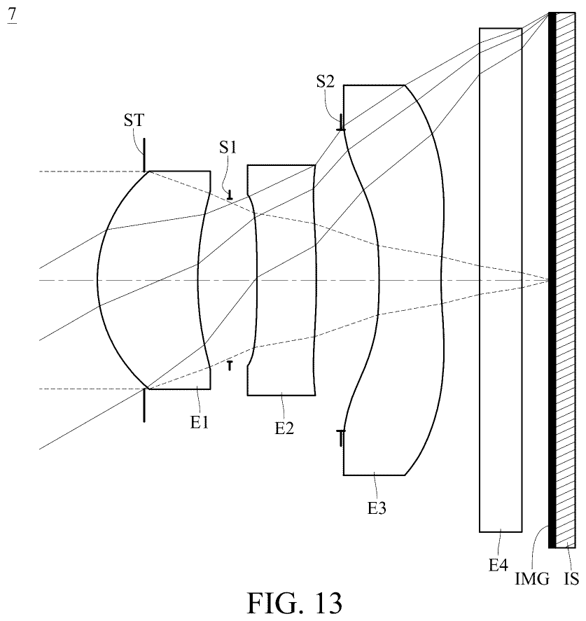

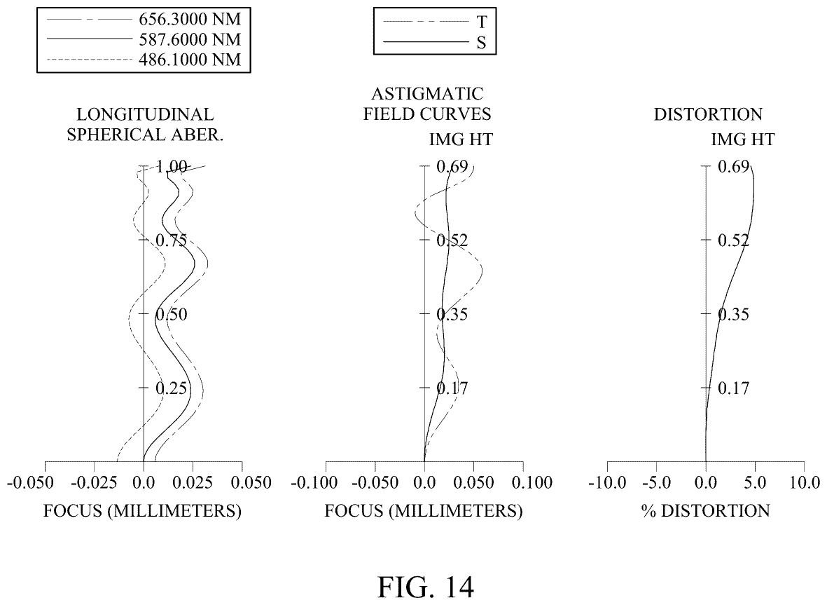

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the photographing optical lens assembly (its reference numeral is omitted) of the present disclosure and an image sensor IS. The photographing optical lens assembly includes, in order from an object side to an image side along an optical axis, an aperture stop ST, a first lens element E1, a stop S1, a second lens element E2, a stop S2, a third lens element E3, a filter E4 and an image surface IMG. The photographing optical lens assembly includes three lens elements (E1, E2 and E3) with no additional lens element disposed between each of the adjacent three lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with positive refractive power has an object-side surface being concave in a paraxial region thereof and an image-side surface being convex in a paraxial region thereof. The second lens element E2 is made of plastic material and has the object-side surface and the image-side surface being both aspheric. The image-side surface of the second lens element E2 has one inflection point. The image-side surface of the second lens element E2 has one critical point in an off-axis region thereof.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The image-side surface of the third lens element E3 has one critical point in an off-axis region thereof.

The filter E4 is made of glass material and located between the third lens element E3 and the image surface IMG, and will not affect the focal length of the photographing optical lens assembly. The image sensor IS is disposed on or near the image surface IMG of the photographing optical lens assembly.

The detailed optical data of the 7th embodiment are shown in Table 7A and the aspheric surface data are shown in Table 7B below.

TABLE 7A
7th Embodiment
f = 1.13 mm, FNO = 2.00, HFOV = 29.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.122 | | | | |
| 2 | Lens 1 | 0.3542 | (ASP) | 0.261 | Plastic | 1.544 | 56.0 | 0.95 |
| 3 | | 0.8323 | (ASP) | 0.083 | | | | |
| 4 | Stop | Plano | | 0.071 | | | | |
| 5 | Lens 2 | −4.5883 | (ASP) | 0.154 | Plastic | 1.639 | 23.5 | 6.67 |
| 6 | | −2.2372 | (ASP) | 0.064 | | | | |
| 7 | Stop | Plano | | 0.099 | | | | |
| 8 | Lens 3 | −1.8617 | (ASP) | 0.161 | Plastic | 1.566 | 37.4 | −1.02 |
| 9 | | 0.8589 | (ASP) | 0.100 | | | | |

| | | | | | | | |
|---|---|---|---|---|---|---|---|
| 10 | Filter | Plano | 0.110 | Glass | 1.517 | 64.2 | — |
| 11 | | Plano | 0.070 | | | | |
| 12 | Image | Plano | — | | | | |

Note:
Reference wavelength is 587.6 nm (d-line).
An effective radius of the stop S1 (Surface 4) is 0.212 mm.
An effective radius of the stop S2 (Surface 7) is 0.391 mm.

TABLE 7B
Aspheric Coefficients

| Surface # | 2 | 3 | 5 |
|---|---|---|---|
| k= | −1.65188E+01 | −6.59805E+01 | −8.89381E+01 |
| A4= | 4.0862348E+01 | 9.2370301E+00 | −2.1184065E+01 |
| A6= | −1.7279938E+03 | 1.4546908E+02 | 4.4128497E+03 |
| A8= | 7.6759795E+04 | −1.9660303E+04 | −5.2734139E+05 |
| A10= | −2.6615521E+06 | 6.8158209E+05 | 3.5364089E+07 |
| A12= | 6.3520818E+07 | −1.1417302E+07 | −1.4260622E+09 |
| A14= | −9.7472603E+08 | 8.8969463E+07 | 3.5108815E+10 |
| A16= | 9.0951531E+09 | −2.4628489E+08 | −5.1461872E+11 |
| A18= | −4.6698905E+10 | — | 4.1012620E+12 |
| A20= | 1.0067557E+11 | — | −1.3606189E+13 |

| Surface # | 6 | 8 | 9 |
|---|---|---|---|
| k= | −4.59995E+01 | −8.25327E+01 | 1.79259E−01 |
| A4= | −5.1189557E+00 | −1.5213411E+01 | −1.5673451E+01 |
| A6= | 3.8725276E+02 | −3.9917133E+02 | 1.5412026E+02 |
| A8= | −9.2146872E+03 | 3.9504969E+04 | 2.5000120E+02 |
| A10= | −3.8437708E+04 | −1.3385483E+06 | −3.3581063E+04 |
| A12= | 7.2746522E+06 | 2.5915020E+07 | 5.0560083E+05 |
| A14= | −1.6662560E+08 | −3.1714878E+08 | −4.1167206E+06 |
| A16= | 1.7766076E+09 | 2.5466298E+09 | 2.0849611E+07 |
| A18= | −9.3438146E+09 | −1.3447612E+10 | −6.7056335E+07 |
| A20= | 1.9534671E+10 | 4.5119690E+10 | 1.3210826E+08 |
| A22= | — | −8.7377733E+10 | −1.4345347E+08 |
| A24= | — | 7.4423571E+10 | 6.4371504E+07 |

In the 7th embodiment, the equation of the aspheric surface profiles of the aforementioned lens elements is the same as the equation of the 1st embodiment. Also, the definitions of these parameters shown in Table 7C are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
Schematic Parameters

| | | | |
|---|---|---|---|
| f [mm] | 1.13 | R1/CT1 | 1.36 |
| FNO | 2.00 | CT1/CT2 | 1.69 |
| HFOV [deg.] | 29.9 | CT1/T23 | 1.60 |
| TL [mm] | 1.173 | T23/CT3 | 1.01 |
| TL/ImgH | 1.70 | CT3/T12 | 1.05 |
| TD/EPD | 1.58 | CTmax/CTmin | 1.69 |
| EPD/ImgH | 0.82 | V2 | 23.5 |
| 10 × \|f3/f2\| | 1.52 | V2 + V3 | 60.9 |
| f/R2 | 1.36 | V1/N1 | 36.27 |
| f/R6 | 1.32 | V2/N2 | 14.34 |
| \|f/R3\| + \|f/R4\| | 0.75 | V3/N3 | 23.88 |
| R2/R6 | 0.97 | Y3R2/CT3 | 3.15 |
| (R2 − R3)/(R2 + R3) | −1.44 | (\|Sag2R1\| + \|Sag2R2\|)/CT2 | 0.18 |
| (R5 + R6)/(R5 − R6) | 0.37 | — | — |

### 8th Embodiment

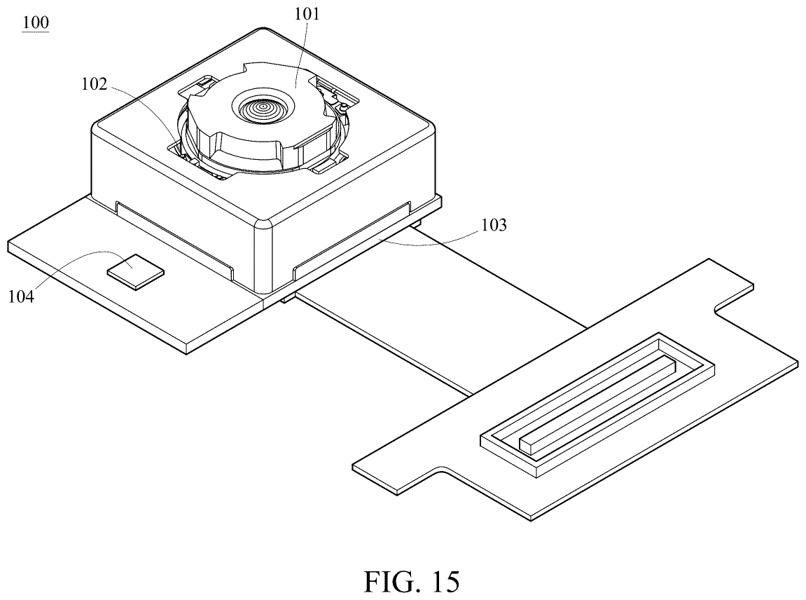

FIG. 15 is a perspective view of an image capturing unit according to the 8th embodiment of the present disclosure. In this embodiment, an image capturing unit 100 is a camera module including a lens unit 101, a driving device 102, an image sensor 103 and an image stabilizer 104. The lens unit 101 includes the photographing optical lens assembly disclosed in the 1st embodiment, a barrel and a holder member (their reference numerals are omitted) for holding the photographing optical lens assembly. However, the lens unit 101 may alternatively be provided with the photographing optical lens assembly disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems, or shape memory alloy materials. The driving device 102 is favorable for obtaining a better imaging position of the lens unit 101, so that a clear image of the imaged object can be captured by the lens unit 101 with different object distances. The image sensor 103 (for example, CCD or CMOS), which can feature high photosensitivity and low noise, is disposed on the image surface of the photographing optical lens assembly to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 9th Embodiment

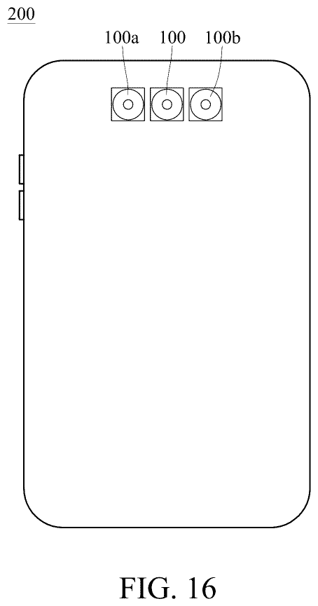

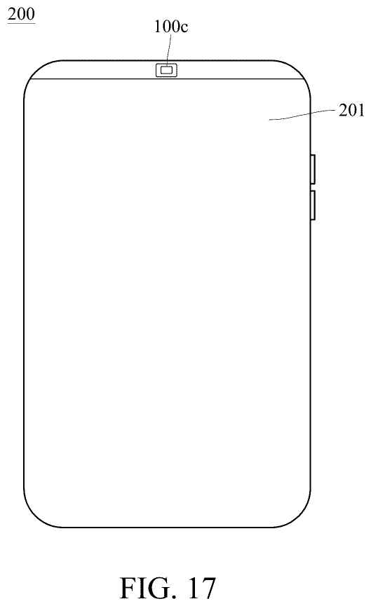

FIG. 16 is a perspective view of an electronic device according to the 9th embodiment of the present disclosure. FIG. 17 is another perspective view of the electronic device in FIG. 16.

In this embodiment, an electronic device 200 is a smartphone including the image capturing unit 100 disclosed in the 8th embodiment, an image capturing unit 100a, an image capturing unit 100b, an image capturing unit 100c and a display unit 201. As shown in FIG. 16, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 17, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the photographing optical lens assembly of the present disclosure and can have a configuration similar to that of the image capturing unit 100. In detail, each of the image capturing units 100a, 100b and 100c can include a lens unit, a driving device, an image sensor and an image stabilizer, and each of the lens unit can include a photographing optical lens assembly such as the photographing optical lens assembly of the present disclosure, a barrel and a holder member for holding the photographing optical lens assembly.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 17, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving compactness of the overall module. In this embodiment, the electronic device 200 includes multiple image capturing units 100, 100a, 100b and 100c, but the present disclosure is not limited to the number and arrangement of image capturing units.

### 10th Embodiment

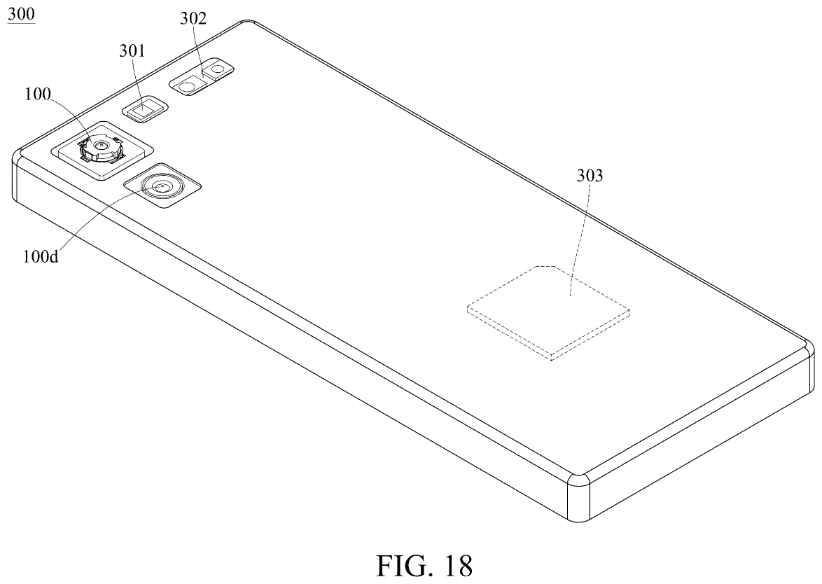

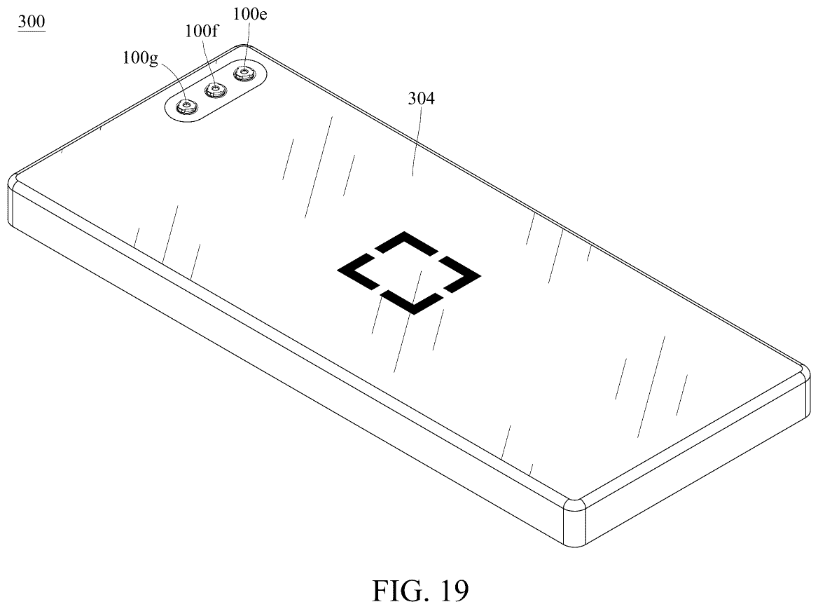

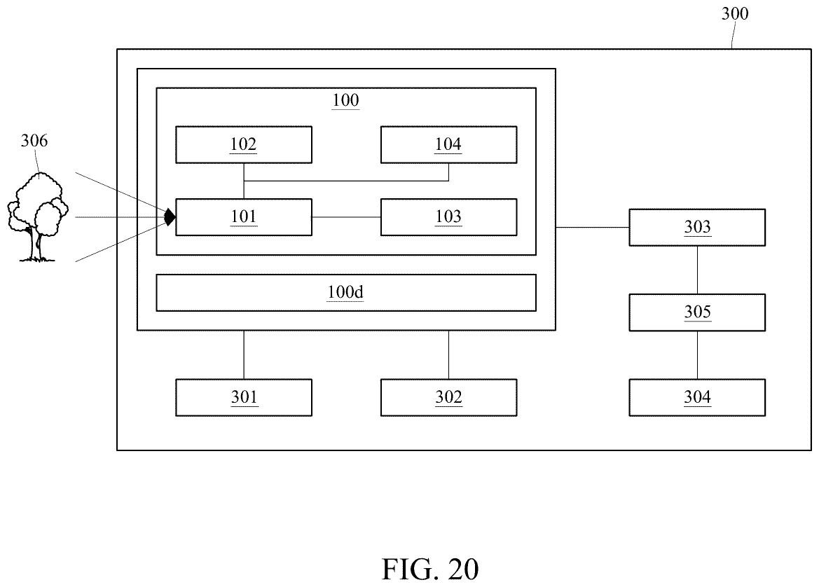

FIG. 18 is a perspective view of an electronic device according to the 10th embodiment of the present disclosure. FIG. 19 is another perspective view of the electronic device in FIG. 18. FIG. 20 is a block diagram of the electronic device in FIG. 18.

In this embodiment, an electronic device 300 is a smartphone including the image capturing unit 100 disclosed in the 8th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, the image capturing unit 100f, the image capturing unit 100g and the display module 304 are disposed on the opposite side of the electronic device 300, and the display module 304 can be a user interface, such that the image capturing units 100e, 100f, 100g can be front-facing cameras of the electronic device 300 for taking selfies, but the present disclosure is not limited thereto. Furthermore, each of the image capturing units 100d, 100e, 100f and 100g can include the photographing optical lens assembly of the present disclosure and can have a configuration similar to that of the image capturing unit 100. In detail, each of the image capturing units 100d, 100e, 100f and 100g can include a lens unit, a driving device, an image sensor and an image stabilizer, and each of the lens unit can include a photographing optical lens assembly such as the photographing optical lens assembly of the present disclosure, a barrel and a holder member for holding the photographing optical lens assembly.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can determine depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 11th Embodiment

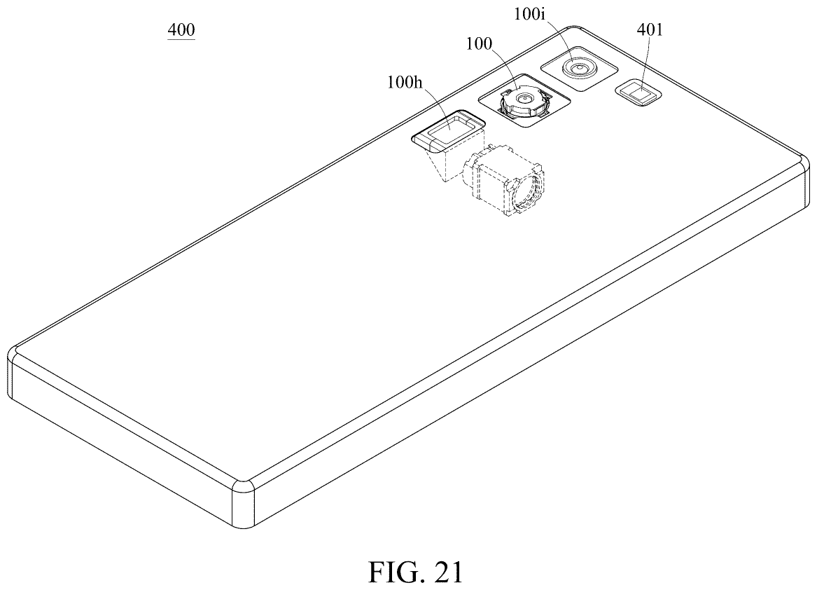

FIG. 21 is a perspective view of an electronic device according to the 11th embodiment of the present disclosure.

In this embodiment, an electronic device 400 is a smartphone including the image capturing unit 100 disclosed in the 8th embodiment, an image capturing unit 100h, an image capturing unit 100i, a flash module 401, a focus assist module, an image signal processor, a display module and an image software processor (not shown). The image capturing unit 100, the image capturing unit 100h and the image capturing unit 100i are disposed on the same side of the electronic device 400, while the display module is disposed on the opposite side of the electronic device 400. Furthermore, each of the image capturing units 100h and 100i can include the photographing optical lens assembly of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. Moreover, the image capturing unit 100h can be a telephoto image capturing unit having a light-folding element configuration, such that the total track length of the image capturing unit 100h is not limited by the thickness of the electronic device 400. Moreover, the light-folding element configuration of the image capturing unit 100h can be similar to, for example, one of the structures shown in FIG. 25 to FIG. 27, which can be referred to foregoing descriptions corresponding to FIG. 25 to FIG. 27, and the details in this regard will not be provided again. In this embodiment, the electronic device 400 includes multiple image capturing units 100, 100h and 100i, but the present disclosure is not limited to the number and arrangement of image capturing units. When a user captures images of an object, light rays converge in the image capturing unit 100, 100h or 100i to generate images, and the flash module 401 is activated for light supplement. Further, the subsequent processes are performed in a manner similar to the abovementioned embodiment, so the details in this regard will not be provided again.

### 12th Embodiment

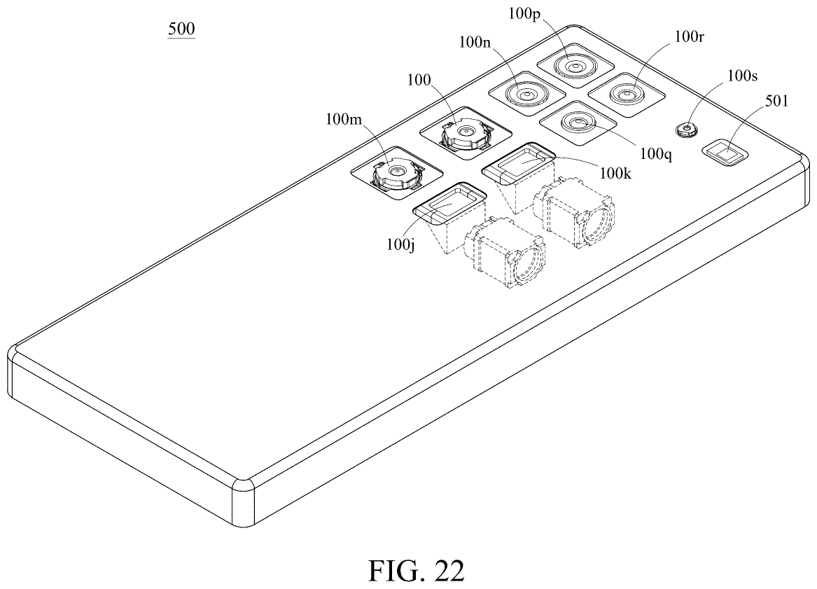

FIG. 22 is a perspective view of an electronic device according to the 12th embodiment of the present disclosure.

In this embodiment, an electronic device 500 is a smartphone including the image capturing unit 100 disclosed in the 8th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the photographing optical lens assembly of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. Moreover, each of the image capturing units 100j and 100k can be a telephoto image capturing unit having a light-folding element configuration. Moreover, the light-folding element configuration of each of the image capturing unit 100j and 100k can be similar to, for example, one of the structures shown in FIG. 25 to FIG. 27, which can be referred to foregoing descriptions corresponding to FIG. 25 to FIG. 27, and the details in this regard will not be provided again. In addition, the image capturing unit 100s can determine depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

The smartphone in several embodiments is only exemplary for showing the image capturing unit of the present disclosure installed in an electronic device, and the present disclosure is not limited thereto. The image capturing unit can be optionally applied to optical systems with a movable focus. Furthermore, the photographing optical lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1A-8C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing optical lens assembly comprising three lens elements, the three lens elements being, in order from an object side to an image side along an optical path, a first lens element, a second lens element and a third lens element, and each of the three lens elements having an object-side surface facing toward the object side and an image-side surface facing toward the image side;
wherein the first lens element has positive refractive power, the object-side surface of the first lens element is convex in a paraxial region thereof, the image-side surface of the first lens element is concave in a paraxial region thereof, the third lens element has negative refractive power, the image-side surface of the third lens element is concave in a paraxial region thereof, and the image-side surface of the third lens element has at least one inflection point;
wherein an Abbe number of the second lens element is V2, an Abbe number of the third lens element is V3, a focal length of the second lens element is f2, a focal length of the third lens element is f3, a central thickness of the third lens element is CT3, an axial distance between the first lens element and the second lens element is T12, a curvature radius of the object-side surface of the third lens element is R5, a curvature radius of the image-side surface of the third lens element is R6, and the following conditions are satisfied:
$$\begin{matrix}10. < V 2 + V 3 < 70. ; \\ 0 < 10 \times \vert f 3 / f 2 \vert < 4.5 ; \\ 0.4 < CT 3 / T 12 < 2.5 ; and \\ 0 < ( R 5 + R 6 ) / R 5 - R 6 ) < 2. .\end{matrix}$$

2. The photographing optical lens assembly of claim 1, wherein the Abbe number of the second lens element is V2, the Abbe number of the third lens element is V3, and the following condition is satisfied:
$$20. < V 2 + V 3 < 65. .$$

3. The photographing optical lens assembly of claim 1, wherein the image-side surface of the second lens element is convex in a paraxial region thereof;
wherein the focal length of the second lens element is f2, the focal length of the third lens element is f3, and the following condition is satisfied:
$$0.01 < 10 \times \vert f 3 / f 2 \vert < 3. .$$

4. The photographing optical lens assembly of claim 1, wherein the object-side surface of the third lens element is concave in a paraxial region thereof;
wherein the central thickness of the third lens element is CT3, the axial distance between the first lens element and the second lens element is T12, and the following condition is satisfied:
$$0.6 < CT 3 / T 12 < 1.75 .$$

5. The photographing optical lens assembly of claim 1, wherein a focal length of the photographing optical lens assembly is f, a curvature radius of the object-side surface of the second lens element is R3, a curvature radius of the image-side surface of the second lens element is R4, and the following condition is satisfied:
$$0.3 < \vert f / R 3 \vert + \vert f / R 4 \vert < 1. .$$

6. The photographing optical lens assembly of claim 1, wherein a curvature radius of the image-side surface of the first lens element is R2, a curvature radius of the object-side surface of the second lens element is R3, and the following condition is satisfied:
$$- 3.00 < ( R 2 - R 3 ) / ( R 2 + R 3 ) < 0.$$

7. The photographing optical lens assembly of claim 1, wherein a central thickness of the first lens element is CT1, a central thickness of the second lens element is CT2, and the following condition is satisfied:
$$1. 30 < CT 1 / CT 2 < 2.3 .$$

8. The photographing optical lens assembly of claim 1, wherein an axial distance between the second lens element and the third lens element is T23, the central thickness of the third lens element is CT3, and the following condition is satisfied:
$$0.5 < T 23 / CT 3 < 130 .$$

9. The photographing optical lens assembly of claim 1, wherein the Abbe number of the second lens element is V2, and the following condition is satisfied:
$$10. < V 2 < 25. .$$

10. The photographing optical lens assembly of claim 1, wherein a maximum effective radius of the image-side surface of the third lens element is Y3R2, the central thickness of the third lens element is CT3, and the following condition is satisfied:
$$1. 50 < Y 3 R 2 / CT 3 < 4. .$$

11. The photographing optical lens assembly of claim 1, wherein a displacement in parallel with an optical axis from an axial vertex on the object-side surface of the second lens element to a maximum effective radius position on the object-side surface of the second lens element is Sag2R1, a displacement in parallel with the optical axis from an axial vertex on the image-side surface of the second lens element to a maximum effective radius position on the image-side surface of the second lens element is Sag2R2, a central thickness of the second lens element is CT2, and the following condition is satisfied:
$$0.03 < ( \vert Sag 2 R 1 \vert + \vert Sag 2 R 2 \vert ) / CT 2 < 0.25 .$$

12. An image capturing unit, comprising:
the photographing optical lens assembly of claim 1; and
an image sensor disposed on an image surface of the photographing optical lens assembly.

13. An electronic device, comprising:
the image capturing unit of claim 12.

14. A photographing optical lens assembly comprising three lens elements, the three lens elements being, in order from an object side to an image side along an optical path, a first lens element, a second lens element and a third lens element, and each of the three lens elements having an object-side surface facing toward the object side and an image-side surface facing toward the image side;
wherein the first lens element has positive refractive power, the object-side surface of the first lens element is convex in a paraxial region thereof, the image-side surface of the first lens element is concave in a paraxial region thereof, the third lens element has negative refractive power, the image-side surface of the third lens element is concave in a paraxial region thereof, and the image-side surface of the third lens element has at least one critical point in an off-axis region thereof;
wherein an Abbe number of the second lens element is V2, an Abbe number of the third lens element is V3, a focal length of the photographing optical lens assembly is f, a focal length of the second lens element is f2, a focal length of the third lens element is f3, a curvature radius of the image-side surface of the first lens element is R2, and the following conditions are satisfied:
$$\begin{matrix}10. < V 2 + V 3 < 70. ; \\ 0 < 10 \times \vert f 3 / f 2 \vert < 4.5 ; and \\ 0.8 < f / R2 < 2 \text{.50} ;\end{matrix}$$
wherein an Abbe number of the first lens element is V1, the Abbe number of the second lens element is V2, the Abbe number of the third lens element is V3, an Abbe number of the i-th lens element is Vi, a refractive index of the first lens element is N1, a refractive index of the second lens element is N2, a refractive index of the third lens element is N3, a refractive index of the i-th lens element is Ni, and at least one lens element of the photographing optical lens assembly satisfies the following condition:
$$5. < Vi / Ni < 14.5 , wherein i = 1 , 2 or 3.$$

15. The photographing optical lens assembly of claim 14, wherein the Abbe number of the second lens element is V2, the Abbe number of the third lens element is V3, and the following condition is satisfied:
$$20. < V 2 + V 3 < 65. .$$

16. The photographing optical lens assembly of claim 14, wherein the focal length of the photographing optical lens assembly is f, the curvature radius of the image-side surface of the first lens element is R2, and the following condition is satisfied:
$$0.9 < f / R 2 < 2.30 .$$

17. The photographing optical lens assembly of claim 14, wherein the Abbe number of the first lens element is V1, the Abbe number of the second lens element is V2, the Abbe number of the third lens element is V3, the Abbe number of the i-th lens element is Vi, the refractive index of the first lens element is N1, the refractive index of the second lens element is N2, the refractive index of the third lens element is N3, the refractive index of the i-th lens element is Ni, and at least one lens element of the photographing optical lens assembly satisfies the following condition:
$$8. < Vi / Ni < 12.5 , wherein i = 1 , 2 or 3.$$

18. The photographing optical lens assembly of claim 14, wherein a maximum value among central thicknesses of all lens elements of the photographing optical lens assembly is CTmax, a minimum value among the central thicknesses of all lens elements of the photographing optical lens assembly is CTmin, and the following condition is satisfied:
$$1. 45 < CT max / CT min < 2.20 .$$

19. The photographing optical lens assembly of claim 14, wherein a curvature radius of the object-side surface of the first lens element is R1, a central thickness of the first lens element is CT1, and the following condition is satisfied:
$$1. 00 < R 1 / CT 1 < 1.5 .$$

20. The photographing optical lens assembly of claim 14, wherein the object-side surface of the second lens element is concave in a paraxial region thereof;
wherein an axial distance between the object-side surface of the first lens element and an image surface is TL, a maximum image height of the photographing optical lens assembly is ImgH, and the following condition is satisfied:
$$1. 40 < TL / ImgH < 2. .$$

21. The photographing optical lens assembly of claim 14, wherein an entrance pupil diameter of the photographing optical lens assembly is EPD, a maximum image height of the photographing optical lens assembly is ImgH, and the following condition is satisfied:
$$0.7 < EPD / ImgH < 0. 90 .$$

22. A photographing optical lens assembly comprising three lens elements, the three lens elements being, in order from an object side to an image side along an optical path, a first lens element, a second lens element and a third lens element, and each of the three lens elements having an object-side surface facing toward the object side and an image-side surface facing toward the image side;
wherein the first lens element has positive refractive power, the object-side surface of the first lens element is convex in a paraxial region thereof, the image-side surface of the first lens element is concave in a paraxial region thereof, the third lens element has negative refractive power, the image-side surface of the third lens element is concave in a paraxial region thereof, and the image-side surface of the third lens element has at least one critical point in an off-axis region thereof;
wherein an Abbe number of the second lens element is V2, an Abbe number of the third lens element is V3, a focal length of the second lens element is f2, a focal length of the third lens element is f3, a curvature radius of the image-side surface of the first lens element is R2, a curvature radius of the image-side surface of the third lens element is R6, an axial distance between the object-side surface of the first lens element and the image-side surface of the third lens element is TD, an entrance pupil diameter of the photographing optical lens assembly is EPD, and the following conditions are satisfied:
$$10. < V 2 + V 3 < 7 0. ;$$
$$0 < 10 \times \vert f 3 / f 2 \vert < 7. ;$$
$$0 < R 2 / R 6 < 2 \text{.00} ;$$
$$and$$
$$1. < TD / EPD < 1.8 .$$

23. The photographing optical lens assembly of claim 22, wherein the Abbe number of the second lens element is V2, the Abbe number of the third lens element is V3, and the following condition is satisfied:
$$30. < V 2 + V 3 < 63.0 .$$

24. The photographing optical lens assembly of claim 22, wherein the curvature radius of the image-side surface of the first lens element is R2, the curvature radius of the image-side surface of the third lens element is R6, and the following condition is satisfied:
$$0.5 < R 2 / R 6 < 1.75 .$$

25. The photographing optical lens assembly of claim 22, wherein a focal length of the photographing optical lens assembly is f, the curvature radius of the image-side surface of the third lens element is R6, and the following condition is satisfied:
$$0.7 < f / R 6 < 2.00 .$$

26. The photographing optical lens assembly of claim 22, wherein a central thickness of the first lens element is CT1, an axial distance between the second lens element and the third lens element is T23, and the following condition is satisfied:
$$1. 40 < CT 1 / T 23 < 2.40 .$$

27. The photographing optical lens assembly of claim 22, wherein an f-number of the photographing optical lens assembly is FNO, half of a maximum field of view of the photographing optical lens assembly is HFOV, and the following conditions are satisfied:
$$1.8 < FNO < 2.2 ;$$
$$and$$
$$26. degrees < HFOV < 35. degrees .$$

28. The photographing optical lens assembly of claim 22, wherein an axial distance between the object-side surface of the first lens element and an image surface is TL, a focal length of the photographing optical lens assembly is f, and the following conditions are satisfied:
$$0.5 mm < TL < 1.8 mm ;$$
$$and$$
$$0.8 mm < f < 1.5 mm .$$

29. The photographing optical lens assembly of claim 22, wherein the Abbe number of the second lens element is V2, the Abbe number of the third lens element is V3, a focal length of the photographing optical lens assembly is f, the focal length of the second lens element is f2, the focal length of the third lens element is f3, a central thickness of the third lens element is CT3, an axial distance between the first lens element and the second lens element is T12, the curvature radius of the image-side surface of the first lens element is R2, a curvature radius of the object-side surface of the third lens element is R5, the curvature radius of the image-side surface of the third lens element is R6, the axial distance between the object-side surface of the first lens element and the image-side surface of the third lens element is TD, the entrance pupil diameter of the photographing optical lens assembly is EPD, and the following conditions are satisfied:
$$36.7 \leq V 2 + V 3 \leq 60.9 ;$$
$$0.11 \leq 10 \times \vert f 3 / f 2 \vert \leq 3.99 ;$$
$$0.81 \leq CT 3 / T 12 \leq 2.1 ;$$
$$0.37 \leq ( R 5 + R 6 ) / ( R 5 - R 6 ) \leq 1.52 ;$$
$$1.07 \leq f / R 2 \leq 2.06 ;$$
$$0.69 \leq R 2 / R 6 \leq 1.5 ;$$
$$and$$
$$1.56 \leq TD / EPD \leq 1.68 ;$$
wherein an Abbe number of the first lens element is V1, the Abbe number of the second lens element is V2, the Abbe number of the third lens element is V3, an Abbe number of the i-th lens element is Vi, a refractive index of the first lens element is N1, a refractive index of the second lens element is N2, a refractive index of the third lens element is N3, a refractive index of the i-th lens element is Ni, and at least one lens element of the photographing optical lens assembly satisfies the following condition:
$$9.61 \leq Vi / Ni \leq 14.34 , wherein i = 1 , 2 or 3.$$
